(19) United States
(12) Patent Application Publication
(10) Pub. No.: US 2024/0323902 A1
(43) Pub. Date: Sep. 26, 2024

(54) LOCATION METHOD AND COMMUNICATION DEVICE

(71) Applicant: VIVO MOBILE COMMUNICATION CO., LTD., Dongguan (CN)

(72) Inventors: Yuanyuan WANG, Dongguan (CN); Peng SUN, Dongguan (CN); Ye SI, Dongguan (CN); Zixun ZHUANG, Dongguan (CN)

(73) Assignee: VIVO MOBILE COMMUNICATION CO., LTD., Dongguan (CN)

(21) Appl. No.: 18/678,061

(22) Filed: May 30, 2024

Related U.S. Application Data
(63) Continuation of application No. PCT/CN2022/135039, filed on Nov. 29, 2022.

(30) Foreign Application Priority Data
Nov. 30, 2021 (CN) 202111447350.9

(51) Int. Cl. H04W 64/00; H04B 17/318; H04W 24/02; H04W 24/10

(52) U.S. Cl. CPC H04W 64/00; H04B 17/328; H04W 24/02; H04W 24/10

(57) ABSTRACT

Disclosed are a location method and a communication device. The location method includes: A first communication device determines whether to use an artificial intelligence network model or an artificial intelligence network model parameter or determines an artificial intelligence network model or artificial intelligence network model parameter to be used according to first information. The artificial intelligence network model is configured to obtain or optimize positioning signal measurement information of a target terminal or location information of the target terminal.

### CROSS-REFERENCE TO RELATED APPLICATIONS

This application is a continuation of International Application No. PCT/CN2022/135039, filed Nov. 29, 2022, which claims priority to Chinese Patent Application No. 202111447350.9, filed Nov. 30, 2021. The entire contents of each of the above-referenced applications are expressly incorporated herein by reference.

### TECHNICAL FIELD

This application belongs to the technical field of wireless communications, and more particularly relates to a location method and a communication device.

### BACKGROUND

New Radio (NR) location is performed based on signal measurements between a network side and a User Equipment (UE, also referred to as terminal). At present, in the field of wireless communication networks, the terminal is often located directly based on positioning signal measurement information. However, in a complex multi-path or non-direct path environment (for example, Non-Line Of Sight (NLOS)), location results often have errors, and requirements cannot be met.

### SUMMARY

Embodiments of this application provide a location method and a communication device.

According to a first aspect, a location method is provided, including:

A first communication device determines whether to use an artificial intelligence network model and/or an artificial intelligence network model parameter and/or determines an artificial intelligence network model and/or artificial intelligence network model parameter to be used according to first information, where the artificial intelligence network model is configured to obtain or optimize positioning signal measurement information of a target terminal and/or location information of the target terminal.

According to a second aspect, a location method is provided, including:

A second communication device receives third information, where the third information includes at least one of the following:
positioning signal measurement information of the target terminal;
location information of the target terminal;
error information, where the error information includes at least one of the following: a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of an artificial intelligence network model and/or artificial intelligence network model parameter; or
LOS indication information.

According to a third aspect, a location apparatus is provided, including:
a first determination module, configured to determine whether to use an artificial intelligence network model and/or an artificial intelligence network model parameter and/or determine an artificial intelligence network model and/or artificial intelligence network model parameter to be used according to first information, where the artificial intelligence network model is configured to obtain or optimize positioning signal measurement information of a target terminal and/or location information of the target terminal.

According to a fourth aspect, a location apparatus is provided, including:
a first receiving module, configured to receive third information, where the third information includes at least one of the following:
positioning signal measurement information of the target terminal;
location information of the target terminal;
error information, where the error information includes at least one of the following: a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of an artificial intelligence network model and/or artificial intelligence network model parameter; or
LOS indication information.

According to a fifth aspect, a communication device is provided. The terminal includes a processor and a memory. The memory stores programs or instructions executable on the processor. The programs or instructions, when executed by the processor, implement the steps of the method as described in the first aspect.

According to a sixth aspect, a communication device is provided, including a processor and a communication interface. The processor is configured to determine whether to use an artificial intelligence network model and/or an artificial intelligence network model parameter and/or determine an artificial intelligence network model and/or artificial intelligence network model parameter to be used according to first information. The artificial intelligence network model is configured to obtain or optimize positioning signal measurement information of a target terminal and/or location information of the target terminal.

According to a seventh aspect, a communication device is provided. The communication device includes a processor and a memory. The memory stores programs or instructions executable on the processor. The programs or instructions, when executed by the processor, implement the steps of the method as described in the second aspect.

According to an eighth aspect, a communication device is provided, including a processor and a communication interface. The communication interface is configured to receive third information. The third information includes at least one of the following:
positioning signal measurement information of a target terminal;
location information of the target terminal;
error information, where the error information includes at least one of the following: a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of an artificial intelligence network model and/or artificial intelligence network model parameter; or
Line Of Sight (LOS) indication information.

According to a ninth aspect, a readable storage medium is provided. The readable storage medium stores programs or instructions. The programs or instructions, when executed by a processor, implement the steps of the method as described in the first aspect or implement the steps of the method as described in the second aspect.

According to a tenth aspect, a chip is provided. The chip includes a processor and a communication interface. The communication interface is coupled to the processor. The processor is configured to execute programs or instructions to implement the method as described in the first aspect or implement the method as described in the second aspect.

According to an eleventh aspect, a computer program product is provided. The computer program product is stored in a storage medium. The computer program product is executed by at least one processor to implement the steps of the location method as described in the first aspect, or the computer program product is executed by at least one processor to implement the steps of the location method as described in the second aspect.

According to a twelfth aspect, a communication device is provided. The communication device is configured to implement the steps of the location method as described in the first aspect or implement the steps of the location method as described in the second aspect.

In this embodiment of this application, a communication device uses an artificial intelligence network model or an artificial intelligence network model parameter to obtain or optimize positioning signal measurement information of a target terminal and/or location information of the target terminal, thus reducing location errors and improving the accuracy of location results.

### BRIEF DESCRIPTION OF THE DRAWINGS

FIG. 1 is a block diagram of a wireless communication system to which embodiments of this application are applicable;

FIG. 2 is a schematic diagram of a neural network according to embodiments of this application;

FIG. 3 is a schematic diagram of neurons according to embodiments of this application;

FIG. 4A is a schematic flowchart of a location method according to an embodiment of this application;

FIG. 4B is a schematic flowchart of a location method according to an embodiment of this application;

FIG. 5 is a schematic flowchart of a location method according to another embodiment of this application;

FIG. 6 is a schematic diagram depicting a structure of a location apparatus according to an embodiment of this application;

FIG. 7 is a schematic diagram depicting a structure of a location apparatus according to another embodiment of this application;

FIG. 8 is a schematic diagram depicting a structure of a communication device according to embodiments of this application;

FIG. 9 is a schematic diagram depicting a hardware structure of a terminal according to embodiments of this application;

FIG. 10 is a schematic diagram depicting a hardware structure of a network-side device according to an embodiment of this application; and

FIG. 11 is a schematic diagram depicting a hardware structure of a network-side device according to another embodiment of this application.

### DETAILED DESCRIPTION

The technical solutions in embodiments of this application are described below with reference to the accompanying drawings in embodiments of this application. Apparently, the described embodiments are merely some rather than all of the embodiments of this application. All other embodiments obtained by those skilled in the art based on embodiments of this application fall within the protection scope of this application.

The terms “first”, “second”, and the like in the specification and claims of this application are used to distinguish similar objects and are not used to describe a particular order or priority. It should be understood that the terms so used are interchangeable where appropriate, whereby embodiments of this application can be practiced in an order other than those illustrated or described herein, and that the objects distinguished by “first” and “second” are generally one class and the number of objects is not limited. For example, there may be one or more first objects. Furthermore, “and/or” in the specification and claims represents at least one of the connected objects, and the character “/” generally represents that the associated objects are in an “or” relationship.

It is to be noted that the technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in embodiments of this application are often used interchangeably, and the described techniques may be used for both the above-mentioned systems and radio technologies and for other systems and radio technologies. The following description describes a New Radio (NR) system for example purposes and uses the NR term in most of the following descriptions, but these technologies may also be applied to applications other than NR system applications, such as 6th Generation (6G) communication systems.

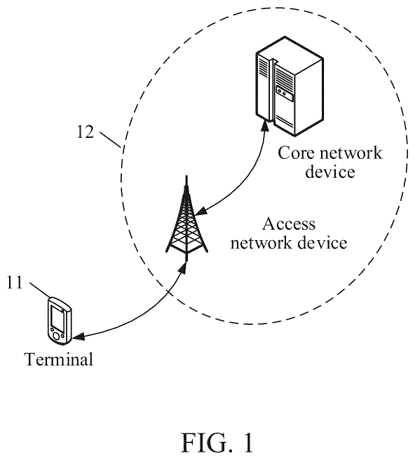

FIG. 1 shows a block diagram of a wireless communication system to which embodiments of this application are applicable. The wireless communication system includes a terminal 11 and a network-side device 12. The terminal 11 may be a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, a vehicle user equipment (VUE), a pedestrian user equipment (PUE), a smart home (home equipment having a wireless communication function, such as a refrigerator, a TV set, a laundry machine or furniture), a game console, a personal computer (PC), a teller machine or an automatic teller machine, or other terminal-side devices. The wearable device includes: smart watches, smart bands, smart headphones, smart glasses, smart jewelry (smart bracelets, smart chain bracelets, smart rings, smart necklaces, smart chain anklets, and the like), smart wristbands, smart clothing, and the like. It should be noted that the specific type of the terminal 11 is not limited in this embodiment of this application. The network-side device 12 may include an access network device or a core network device. The access network device 12 may also be referred to as a radio access network device, a Radio Access Network (RAN), a radio access network function, or a radio access network unit. The access network device 12 may include a base station, a Wireless Local Arca Network (WLAN) access point, a Wireless Fidelity (WiFi) node, or the like. The base station may be referred to as a node B, an evolved node B (eNB), an access point, a Base Transceiver Station (BTS), a radio base station, a radio transceiver, a Basic Service Set (BSS), an Extended Service Set (ESS), a home Node B, a home evolved Node B, a Transmitting Receiving Point (TRP), or some other suitable terms in the art. The base station is not limited to specific technical vocabulary, provided that the same technical effects are achieved. It should be noted that in this embodiment of this application, only a base station in an NR system is described as an example, but the specific type of the base station is not limited. The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), a Location Management Function (LMF), an Evolved Serving Mobile Location Center (E-SMLC), a 5G network data analytics function (5G NWDAF), or the like. It should be noted that in this embodiment of this application, only a core network device in an NR system is described as an example, but the specific type of the core network device is not limited.

A location method and a communication device provided by embodiments of this application are described below in detail through some embodiments and application scenarios thereof with reference to the drawings.

An Artificial Intelligence (AI) network model involved in this embodiment of this application is first described below.

The artificial intelligence network model has been widely used in various fields at present. The artificial intelligence network model is implemented as, for example, a neural network, a decision tree, a support vector machine, a Bayes classifier, and the like. In this application, a neural network is taken as an example. However, the application of the other artificial intelligence network models is not limited.

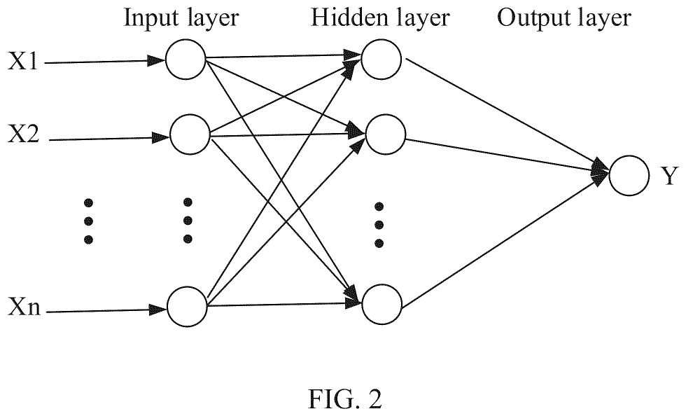

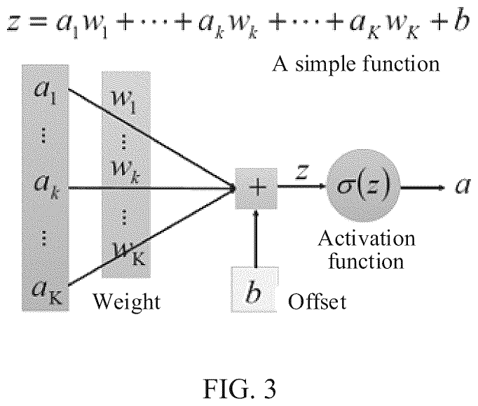

A schematic diagram of a neural network is shown in FIG. 2. The neural network is composed of neurons. The neurons are shown in FIG. 3, where a1, a2, . . . , aK are inputs, w is a weight (multiplicative coefficient), b is an offset (additive coefficient), and σ (·) is an activation function. Common activation functions include Sigmoid, tanh, a linear rectifier function, a Rectified Linear Unit (ReLU), and the like.

Parameters of the neural network are optimized by an optimization algorithm. The optimization algorithm is an algorithm that minimizes or maximizes an objective function (or a loss function). The objective function is often a mathematical combination of model parameters and data. For example, data X and a corresponding label Y (namely, a true value) are given to construct a neural network model f(·). With the model, a predicted output f(x) may be obtained according to the input X, and a difference (f(x)−Y) between a predicted value and a real value may be calculated, which is the loss function. The purpose of the optimization algorithm is to find suitable w and b to minimize the value of the loss function. As the loss value is smaller, the model is closer to the real situation.

At present, the common optimization algorithms are basically error back propagation (error Back Propagation, BP)-based algorithms. The basic idea of the BP algorithm is that a learning process is composed of signal forward propagation and error back propagation. During the forward propagation, input samples are transmitted from an input layer, processed by hidden layers layer by layer, and then transmitted to an output layer. If an actual output of the output layer is inconsistent with an expected output, the process proceeds to the error back propagation. The error back propagation is to back-propagate output errors to the input layer by hidden layers layer by layer in some form, and distribute the errors to all units in the layers, so as to obtain an error signal of each unit of each layer, where the error signal is the basis for correcting a weight value of each unit. The weight adjustment process of each layer of the signal forward propagation and the error back propagation is carried out repeatedly. The process of constant weight adjustment is also the learning and training process of networks. This process is carried out until the errors of network output are reduced to an acceptable level, or until a preset number of learning is carried out.

Common optimization algorithms include gradient descent, stochastic gradient descent (SGD), mini-batch gradient descent, momentum, Nesterov (inventor's name, specifically stochastic gradient descent with momentum), Adaptive Gradient descent (Adagrad), Adaptive Delta (Adadelta), root mean square prop (RMSprop), Adaptive Moment Estimation (Adam), and the like.

During error back propagation, these optimization algorithms calculate a derivative/partial derivative of a current neuron according to an error/loss obtained by a loss function, obtain a gradient based on the influence of a learning rate and the previous gradient/derivative/partial derivative, and transmit the gradient to an upper layer.

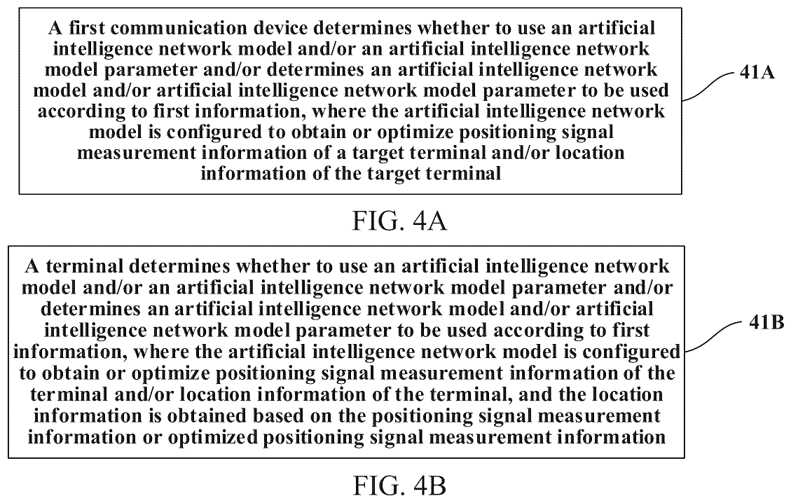

Referring to FIG. 4A, embodiments of this application provide a location method, including:

Step 41A: A first communication device determines whether to use an artificial intelligence network model and/or an artificial intelligence network model parameter and/or determines an artificial intelligence network model and/or artificial intelligence network model parameter to be used according to first information, where the artificial intelligence network model is configured to obtain or optimize positioning signal measurement information of a target terminal and/or location information of the target terminal.

In this embodiment of this application, a communication device uses an artificial intelligence network model or an artificial intelligence network model parameter to obtain or optimize positioning signal measurement information of a target terminal and/or location information of the target terminal, thus reducing location errors and improving the accuracy of location results.

The first communication device may be a terminal or a network-side device. The network side device may be an LMF, an NWDAF, or an artificial intelligence function module.

In some embodiments, the first information includes at least one of the following:
line of sight (LOS) indication information;
a preset condition;
a preset event;
configuration information, where the configuration information is used for configuring one or more artificial intelligence network models, and/or configuring one or more sets of artificial intelligence network model parameters, and/or indicating whether to use an artificial intelligence network model to obtain or optimize positioning signal measurement information of a target terminal and/or location information of the target terminal;
priority information, where the priority information is used for agreeing event, condition or cell-defaulted or initially-activated or preferentially-used artificial intelligence network models and/or artificial intelligence network model parameters;
environmental information of the target terminal;
reference information transmitted by a reference terminal;
positioning signal measurement information of the target terminal; or
location information of the target terminal.

In some embodiments, the positioning signal measurement information of the target terminal includes at least one of the following:
channel response information of a positioning signal;
a Reference Signal Time Difference (RSTD) measurement result;
Round trip time (RTT);
multi-round trip time;
an Angle of Arrival (AOA) measurement result;
an Angle of Departure (AOD) measurement result; or
Reference Signal Received Power (RSRP).

In some embodiments, the positioning signal measurement information is associated with or includes at least one piece of LOS indication information.

In some embodiments, the positioning signal measurement information includes positioning signal measurement information of at least one path.

In some embodiments, the positioning signal measurement information includes at least one of the following:
angle information of a path;
time information of a path;
energy information of a path; or
LOS indication information.

In some embodiments, the positioning signal measurement information of at least one path includes at least one piece of LOS indication information.

In some embodiments, the positioning signal measurement information of each path includes LOS indication information.

In some embodiments, the LOS indication information is used for indicating one of the following:
an LOS condition between the target terminal and a target transmitting receiving point (TRP);
an LOS condition of the target terminal; or
an LOS condition between one or more location reference signal resources of the target terminal and a target TRP.

In some embodiments, the LOS indication information includes at least one of the following:
a first bit for indicating being an LOS or a non-line of sight (NLOS);
a second bit for indicating a probability of being an LOS; or
a third bit for indicating a confidence of being an LOS.

In some embodiments, the LOS indication information includes at least one of the following:
a first bit for indicating positioning signal measurement being an LOS or a non-line of sight (NLOS);
a second bit for indicating a probability of positioning signal measurement being an LOS; or
a third bit for indicating a confidence of positioning signal measurement being an LOS.

In some embodiments, the operation that a first communication device determines an artificial intelligence network model and/or an artificial intelligence network model parameter according to first information further includes:

The terminal determines LOS indication information based on a second artificial intelligence network model.

In some embodiments, after the first communication device determines an artificial intelligence network model and/or artificial intelligence network model parameter to be used according to first information, the method further includes:

The first communication device reports third information, where the third information includes at least one of the following:
positioning signal measurement information of the target terminal;
location information of the target terminal;
error information, where the error information includes at least one of the following: a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of the artificial intelligence network model and/or artificial intelligence network model parameter; or
LOS indication information.

In some embodiments, the location method further includes:

The first communication device reports associated information of the LOS indication information, where the associated information includes at least one of the following:
an LOS confidence; or
second information for determining the LOS indication information.

In some embodiments, the second information includes at least one of the following:
a second artificial intelligence network model for determining the LOS indication information;
Channel Impulse Response (CIR);
power of first-path;
power of multi-path;
delay of first-path;
time of arrival (TOA) of first-path;
reference signal time difference (RSTD) of first-path;
delay of multi-path;
TOA of multi-path;
RSTD of multi-path;
angle of arrival of first-path;
angle of arrival of multi-path;
antenna subcarrier phase difference of first-path;
antenna subcarrier phase difference of multi-path;
average excess delay;
root mean square delay extension; or coherent bandwidth.

In some embodiments, the artificial intelligence network model parameter includes at least one of the following:
a structure of the artificial intelligence network model;
a multiplicative coefficient, an additive coefficient, and/or an activation function of each neuron of the artificial intelligence network model;
complexity information of the artificial intelligence network model;
an expected training number of the artificial intelligence network model;
an application document of the artificial intelligence network model;
an input format of the artificial intelligence network model; or
an output format of the artificial intelligence network model.

In some embodiments, the operation that the first communication device determines an artificial intelligence network model and/or artificial intelligence network model parameter to be used according to first information includes:

The first communication device indicates, configures or activates a target artificial intelligence network model and/or a target artificial intelligence network model parameter according to the first information.

In some embodiments, the operation that the first communication device indicates, configures or activates a target artificial intelligence network model and/or a target artificial intelligence network model parameter according to the first information includes one of the following:

The first communication device indicates, configures or activates a first target artificial intelligence network model and/or a first target artificial intelligence network model parameter in response to the LOS indication information indicating being an LOS.

The first communication device indicates, configures or activates a second target artificial intelligence network model and/or a second target artificial intelligence network model parameter in response to the LOS indication information indicating being an NLOS.

The first communication device indicates, configures or activates the first target artificial intelligence network model and/or the first target artificial intelligence network model parameter in response to that a probability of being an LOS indicated by the LOS indication information is greater than or equal to a first threshold.

The first communication device indicates, configures or activates the second target artificial intelligence network model and/or the second target artificial intelligence network model parameter in response to that a probability of being an LOS indicated by the LOS indication information is less than or equal to a second threshold.

In some embodiments, the first communication device indicates, configures or activates the target artificial intelligence network model and/or the target artificial intelligence network model parameter according to the preset condition.

In some embodiments, the preset condition includes a first preset condition and a second preset condition, and the operation that the first communication device indicates, configures or activates a target artificial intelligence network model and/or a target artificial intelligence network model parameter according to the first information includes:

The first communication device indicates, configures or activates a first target artificial intelligence network model and/or a first target artificial intelligence network model parameter in response to satisfying the first preset condition.

The first communication device indicates, configures or activates a second target artificial intelligence network model and/or a second target artificial intelligence network model parameter in response to satisfying the second preset condition.

In some embodiments, the first communication device indicates, configures or activates the target artificial intelligence network model and/or the target artificial intelligence network model parameter according to the plurality of preset conditions.

In some embodiments, the preset condition includes at least one of the following: a channel model is an LOS;
a probability of an LOS is greater than or equal to a first threshold;
an RSRP of a target cell is greater than or equal to a third threshold;
a transmitting timer (Rx Timing) or TOA of the target cell is less than or equal to a fourth threshold;
a difference between the Rx Timing or TOA of the target cell and a serving cell is less than or equal to a fifth threshold;
a multi-path distribution satisfies a first condition;
a related bandwidth is greater than or equal to a sixth threshold; or
a multi-antenna measurement result satisfies a second condition.

Or:

The preset condition includes at least one of the following:
a channel model is an NLOS;
a probability of an LOS is less than or equal to a second threshold;
an RSRP of a target cell is less than or equal to a seventh threshold;
an Rx Timing or TOA of the target cell is greater than or equal to an eighth threshold;
a difference between the Rx Timing or TOA of the target cell and a serving cell is greater than or equal to a ninth threshold;
a multi-path distribution does not satisfy a first condition;
a related bandwidth is less than or equal to a tenth threshold; or
a multi-antenna measurement result does not satisfy a second condition.

In some embodiments, the first communication device indicates, configures or activates the target artificial intelligence network model and/or the target artificial intelligence network model parameter according to the preset event.

In some embodiments, the first communication device indicates, configures or activates the target artificial intelligence network model and/or the target artificial intelligence network model parameter according to the plurality of preset events.

In some embodiments, the preset event includes a first preset event and a second preset event, and the operation that the first communication device indicates, configures or activates a target artificial intelligence network model and/or a target artificial intelligence network model parameter according to the first information includes:

The first communication device indicates, configures or activates a first target artificial intelligence network model and/or a first target artificial intelligence network model parameter in response to the first preset event being triggered.

The first communication device indicates, configures or activates a second target artificial intelligence network model and/or a second target artificial intelligence network model parameter in response to the second preset event being triggered.

In some embodiments, the preset event includes at least one of the following: a Quality of Service (QOS) event;
a periodic event;
an event in which an absolute location variance is greater than or equal to an eleventh threshold;
an event in which a multi-measurement variance is greater than or equal to a twelfth threshold;
a Radio Link Failure (RLF) event;
a Radio Resource Management (RRM) event;
a Beam Failure (BF) event;
a Beam Failure Recover (BFR) event;
timing measurement;
Timing Advance (TA) measurement;
an event in which a round trip time (RTT) measurement error or variance is excessive;
an event in which an Observed Time Difference of Arrival (OTDOA) measurement error or variance is excessive;
an event in which a time difference of arrival (TDOA) measurement error or variance is excessive;
an event in which an RSRP measurement error or variance is excessive;
an event in which an RSRP measurement is lower than a thirteenth threshold;
an event in which a measurement error or variance of a reference terminal is excessive;
report failure of a reference terminal; or
an event in which a location error or variance of a reference terminal is excessive.

In some embodiments, the measurement error or variance of the reference terminal includes at least one of the following:
a timing or timing advance-based measurement error or variance;
a round trip event-based measurement error or variance;
an OTDOA-based measurement error or variance;
a TDOA-based measurement error or variance;
an RSRP-based measurement error or variance; or
error information of the reference terminal.

In some embodiments, the reference information of the reference terminal includes at least one of the following:
identification information of the reference terminal;
location information of the reference terminal;
measurement information of the reference terminal;
error information of the reference terminal;
an artificial intelligence network model used by the reference terminal; or
an artificial intelligence network model parameter used by the reference terminal.

In some embodiments, the first communication device indicates, configures or activates the target artificial intelligence network model and/or the target artificial intelligence network model parameter according to the environmental information.

In some embodiments, the operation that the first communication device indicates, configures or activates a target artificial intelligence network model and/or a target artificial intelligence network model parameter according to the first information further includes:

The first communication device indicates, configures or activates a first target artificial intelligence network model and/or a first target artificial intelligence network model parameter in response to the environmental information being a first environment.

The first communication device indicates, configures or activates a second target artificial intelligence network model and/or a second target artificial intelligence network model parameter in response to the environmental information being a second environment.

In some embodiments, the first communication device indicates, configures or activates the target artificial intelligence network model and/or the target artificial intelligence network model parameter according to the environmental information.

In some embodiments, the priority information includes at least one of the following:
preferential use of first-ranked artificial intelligence network models and/or artificial intelligence network model parameters;
preferential use of specified artificial intelligence network models and/or artificial intelligence network model parameters;
preferential use of associated artificial intelligence network models and/or artificial intelligence network model parameters;
preferential use of artificial intelligence network models and/or artificial intelligence network model parameters having small identifiers (ID);
preferential use of artificial intelligence network models and/or artificial intelligence network model parameters having large IDs;
preferential use of artificial intelligence network models and/or artificial intelligence network model parameters having large data volume;
preferential use of artificial intelligence network models and/or artificial intelligence network model parameters having small data volume;
preferential use of artificial intelligence network models and/or artificial intelligence network model parameters having complex model structures;
preferential use of artificial intelligence network models and/or artificial intelligence network model parameters having simple model structures;
preferential use of artificial intelligence network models and/or artificial intelligence network model parameters having many model layers;
preferential use of artificial intelligence network models and/or artificial intelligence network model parameters having few model layers;
preferential use of artificial intelligence network models and/or artificial intelligence network model parameters having high quantification levels;
preferential use of artificial intelligence network models and/or artificial intelligence network model parameters having low quantification levels;
preferential use of artificial intelligence network models and/or artificial intelligence network model parameters having fully connected neural network structures; or
preferential use of artificial intelligence network models and/or artificial intelligence network model parameters having convolutional neural network structures.

In some embodiments, the location method further includes:

The first communication device reports capability information, where the capability information includes at least one of the following:
whether to support an artificial intelligence network model and/or an artificial intelligence network model parameter;
whether to support a plurality of artificial intelligence network models and/or a plurality of sets of artificial intelligence network model parameters; or
whether to support using an artificial intelligence network model and/or an artificial intelligence network model parameter to obtain or optimize positioning signal measurement information.

The first communication device may be a terminal, an access network device, or a core network device.

The location method is described below by the first communication device being a terminal.

In some embodiments, the first communication device indicates, configures or activates the target artificial intelligence network model and/or the target artificial intelligence network model parameter according to one or more pieces of information in the first information.

The “indication” may be understood as indicating that another communication device uses or employs the target artificial intelligence network model and/or the target artificial intelligence network model parameter.

The “configuration” may be understood as indicating that the one or more target artificial intelligence network models and/or target artificial intelligence network model parameters are configured to a target device.

The “activation” may be understood as activating the one or more target artificial intelligence network models and/or target artificial intelligence network model parameters to be configured to the target device.

The target device may be a first communication device or a second communication device for locating using the target artificial intelligence network model and/or the target artificial intelligence network model parameter.

Referring to FIG. 4B, embodiments of this application provide a location method, including:

Step 41B: A terminal determines whether to use an artificial intelligence network model and/or an artificial intelligence network model parameter and/or determines an artificial intelligence network model and/or artificial intelligence network model parameter to be used according to first information, where the artificial intelligence network model is configured to obtain or optimize positioning signal measurement information of the terminal and/or location information of the terminal, and the location information is obtained based on the positioning signal measurement information or optimized positioning signal measurement information.

In this embodiment of this application, a terminal uses an artificial intelligence network model or an artificial intelligence network model parameter to obtain or optimize positioning signal measurement information of the terminal and/or location information of the terminal, thus reducing location errors and improving the accuracy of location results.

In this embodiment of this application, the first information includes at least one of the following:
1) Line of sight (LOS) indication information.
2) Preset condition.
3) Preset event.
4) Configuration information, where the configuration information is used for configuring one or more artificial intelligence network models, and/or configuring one or more sets of artificial intelligence network model parameters, and/or indicating whether to use an artificial intelligence network model to obtain or optimize positioning signal measurement information of the terminal and/or location information of the terminal.

If an artificial intelligence network model or a set of artificial intelligence network model parameters is used to cope with all environments and scenarios, the flexibility is insufficient, and it is difficult to guarantee the performance in complex environments. Therefore, in this embodiment of this application, a plurality of artificial intelligence network models or a plurality of sets of artificial intelligence network model parameters may be configured, so that an artificial intelligence network model or a set of artificial intelligence network model parameters may be selected for use according to different environments or scenarios, thereby improving the flexibility.
5) Priority information, where the priority information is used for agreeing event, condition or cell-defaulted or initially-activated or preferentially-used artificial intelligence network models and/or artificial intelligence network model parameters.

In some embodiments, the event is a current event or another event. The cell is a current cell or another cell.
6) Environmental information of the terminal.

The environmental information is, for example, environmental classification information. The environmental classification information includes, for example, an indoor environment, an outdoor environment, a complex environment, or a simple environment. For another example, an agreed environment type is, for example, Inf-DH (dense clutter, high saturation magnetic induction (high BS)), Inf-SH (sparse clutter, high BS), Inf-DL (dense clutter, low saturation magnetic induction (low BS)), Inf-SL (sparse clutter, low BS), and the like.
7) Reference information transmitted by a reference terminal.

The reference terminal is, for example, a terminal having a fixed location such as a fixed roadside device.

The reference terminal is, for example, a terminal having a prescribed trajectory, such as a patrol robot.
8) Positioning signal measurement information of the terminal.
9) Location information of the terminal.

The location information may be absolute location information (for example, latitude and longitude information) or relative location information.

The positioning signal measurement information of the terminal and the location information of the terminal are obtained by measurement, which is different from 1)-7).

In some embodiments, the positioning signal measurement information and/or positioning signal may be obtained by an Observed Time Difference of Arrival (OTDOA), a Global Navigation Satellite System (GNSS), a downlink time difference of arrival (DL-TDOA), an uplink time difference of arrival (UL-TDOA), an uplink angle of arrival (AoA), an angle of departure (AoD), a Round trip time (RTT), a multi-round trip time (Multi-RTT), Bluetooth, a sensor, or WiFi.

In this embodiment of this application, the positioning signal measurement information of the target terminal includes at least one of the following:
channel response information of a positioning signal;
a Reference Signal Time Difference (RSTD) measurement result;
Round Trip Time (RTT);
multi-round trip time (Multi-RTT);
an Angle of Arrival (AOA) measurement result;
an Angle of Departure (AOD) measurement result; or
Reference Signal Received Power (RSRP).

In this embodiment of this application, the positioning signal measurement information is associated with or includes at least one piece of LOS indication information.

In this embodiment of this application, the positioning signal measurement information includes positioning signal measurement information of at least one path.

In this embodiment of this application, the positioning signal measurement information includes at least one of the following:
1) Angle information of a path, for example, path AOA and path AoD.
2) Time information of a path.

The time information is, for example, a path reference signal time difference (Reference Signal Time Difference, RSTD, such as an additional path RSTD or path RSTD) measurement result, a path round-trip time (Path RTT), a path TOA or path Rx-Tx (receiving-transmitting) measurement result.
3) Energy information of a path, for example, path RSRPP (path RSRP, RSRPP).
4) LOS indication information.

In this embodiment of this application, the positioning signal measurement information of at least one path includes at least one piece of LOS indication information. Further, the positioning signal measurement information of each path includes LOS indication information.

In one embodiment, the positioning signal measurement information of at least one path may be understood as that positioning signal measurement information corresponding to one timestamp includes positioning signal measurement information of at least two paths. In another embodiment, the positioning signal measurement information of at least one path may be understood as that positioning signal identification information is associated with positioning signal identification information of at least one path.

Furthermore, in one embodiment, the positioning signal measurement information includes positioning signal measurement information of at least one path and positioning signal measurement information of a path not distinguished. For example, the RSRP and the RSRPP are reported together, the path RSTD and the RSRPP are reported together, the path RSTD and the RSTD are reported together, and the path Rx-Tx and the RSRPP are reported together.

In this embodiment of this application, the LOS indication information is used for indicating one of the following:
an LOS condition between the terminal and a target transmitting receiving point (TRP);
an LOS condition of the terminal; or
an LOS condition between one or more location reference signal resources of the terminal and a target TRP.

In this embodiment of this application, the LOS indication information includes at least one of the following:
1) First bit for indicating being an LOS or a non-line of sight (NLOS).

For example, 0 or 1 is used for representing being an LOS or an NLOS.
2) Second bit for indicating a probability of being an LOS.

For example, M bits {0, 0.X, 2*0.X, . . . , 1} are used for indicating a probability of being an LOS.
3) Third bit for indicating a confidence of being an LOS.

In this embodiment of this application, the LOS indication information includes at least one of the following:
a first bit for indicating positioning signal measurement being an LOS or a Non-Line Of Sight (NLOS);
a second bit for indicating a probability of positioning signal measurement being an LOS; or
a third bit for indicating a confidence of positioning signal measurement being an LOS.

The LOS situation between the terminal and the target transmitting receiving point (TRP) may be understood as whether an LOS or an NLOS is between the terminal and the target transmitting receiving point (TRP), or whether an LOS is included, or a probability of including the LOS.

The LOS condition of the terminal may be understood as that the terminal includes at least N LOSs or at most M LOSs.

The LOS condition between one or more location reference signal resources of the terminal and a target TRP may be understood as respectively indicating an LOS situation between location reference signals A of the terminal and the target TRP or an LOS situation between location reference signals B of the terminal and the target TRP, where the location reference signals A and B refer to selected location reference signals, and the number may be extended to ABCDEFGH and the like.

In this embodiment of this application, the operation that a terminal determines an artificial intelligence network model and/or an artificial intelligence network model parameter according to first information further includes:

The terminal determines LOS indication information based on a second artificial intelligence network model.

The second artificial intelligence network model may be a pre-configured network model.

In the embodiment, the terminal determines the LOS indication information based on the artificial intelligence network model. In one embodiment, the second artificial intelligence network model is an artificial intelligence network model stored by a UE or used by the UE.

In this embodiment of this application, after determining an artificial intelligence network model and/or artificial intelligence network model parameter to be used according to first information, the method further includes:

Third information is reported, where the third information includes at least one of the following:
positioning signal measurement information of the target terminal;
location information of the target terminal;
error information, where the error information includes at least one of the following: a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of the artificial intelligence network model and/or artificial intelligence network model parameter; or
LOS indication information.

In this embodiment of this application, the location method further includes: The terminal reports associated information of the LOS indication information, where the associated information includes at least one of the following:
an LOS confidence; or
second information for determining the LOS indication information.

In this embodiment of this application, the second information includes at least one of the following:
1) Second artificial intelligence network model for determining the LOS indication information.

Some key parameters of the artificial intelligence network model may be included. If the composition of a training set, specific training parameters, hyper-parameters (hyper-parameter) of a neural network, and the like to be shown to the network are determined based on the neural network, or neural network parameters corresponding to the network may be directly shown.
2) Channel Impulse Response (CIR).
3) Power of first-path.
4) Power of multi-path.

In this embodiment of this application, the power may be an absolute power or a relative power. The relative power is, for example, power relative to a signal RSRP. For example, multi-path is relative to first-path, and multi-path is relative to signals.
5) Delay of first-path.
6) Time Of Arrival (TOA) of first-path.
7) Reference Signal Time Difference (RSTD) of first-path.
8) Delay of multi-path.

In this embodiment of this application, the delay may be an absolute delay or a relative delay. The relative delay is, for example, relative to a signal delay. For example, multi-path is relative to first-path, and multi-path is relative to signals.
9) TOA of multi-path.
10) RSTD of multi-path.
11) Angle of arrival of first-path.
12) Angle of arrival of multi-path.
13) Antenna subcarrier phase difference of first-path.
14) Antenna subcarrier phase difference of multi-path.
15) Average excess delay.
16) Root mean square delay extension.
17) Coherent bandwidth.

In this embodiment of this application, the artificial intelligence network model parameter includes at least one of the following:
1) Structure of the artificial intelligence network model.

The structure includes, for example, at least one of the following:
a fully connected neural network, a convolutional neural network, a recurrent neural network, or a residual network;
a combination mode of a plurality of small networks, for example, fully connected+convolutional, convolutional+residual, and the like;
the number of hidden layers;
a connection mode between an input layer and a hidden layer, a connection mode between a plurality of hidden layers, and/or a connection mode between a hidden layer and an output layer; or
the number of neurons in each layer.
2) Multiplicative coefficient, additive coefficient, and/or activation function of each neuron of the artificial intelligence network model.
3) Complexity information of the artificial intelligence network model.
4) Expected training number of the artificial intelligence network model.
5) Application document of the artificial intelligence network model.
6) Input format of the artificial intelligence network model.
7) Output format of the artificial intelligence network model.

In this embodiment of this application, the operation that the terminal determines an artificial intelligence network model and/or artificial intelligence network model parameter to be used according to first information includes:

A target artificial intelligence network model and/or a target artificial intelligence network model parameter are indicated, configured or activated according to the first information.

In this embodiment of this application, the operation that a target artificial intelligence network model and/or a target artificial intelligence network model parameter are indicated, configured or activated according to the first information includes one of the following:

A first target artificial intelligence network model and/or a first target artificial intelligence network model parameter are indicated, configured or activated in response to the LOS indication information indicating being an LOS.

A second target artificial intelligence network model and/or a second target artificial intelligence network model parameter are indicated, configured or activated in response to the LOS indication information indicating being an NLOS.

The first target artificial intelligence network model and/or the first target artificial intelligence network model parameter are indicated, configured or activated in response to that a probability of being an LOS indicated by the LOS indication information is greater than or equal to a first threshold.

The second target artificial intelligence network model and/or the second target artificial intelligence network model parameter are indicated, configured or activated in response to that a probability of being an LOS indicated by the LOS indication information is less than or equal to a second threshold.

In this embodiment of this application, the operation that a target artificial intelligence network model and/or a target artificial intelligence network model parameter are indicated, configured or activated according to the first information includes:

The target artificial intelligence network model and/or the target artificial intelligence network model parameter are indicated, configured or activated in response to satisfying a preset condition.

In this embodiment of this application, the preset condition includes a first preset condition and a second preset condition, and the operation that the first communication device indicates, configures or activates a target artificial intelligence network model and/or a target artificial intelligence network model parameter according to the first information includes:

The first target artificial intelligence network model and/or the first target artificial intelligence network model parameter are indicated, configured or activated in response to satisfying the first preset condition.

The second target artificial intelligence network model and/or the second target artificial intelligence network model parameter are indicated, configured or activated in response to satisfying the second preset condition.

It is worth noting that the indication or configuration or activation may be that a network-side device activates a terminal, or the terminal configures and activates the network device. Even in one embodiment, the network-side device updates an artificial intelligence network model and parameter of the terminal, or the terminal updates an artificial intelligence network model and parameter of the network-side device.

In another embodiment, indicating, configuring or activating a target artificial intelligence network model and/or a target artificial intelligence network model parameter according to the first information may be understood as updating the artificial intelligence network model and/or the target artificial intelligence network model parameter according to the first information.

In this embodiment of this application, the preset condition includes at least one of the following:
a channel model is an LOS;
a probability of an LOS is greater than or equal to a first threshold;
an RSRP of a target cell is greater than or equal to a third threshold;
an Rx Timing (receiving timing) or TOA of the target cell is less than or equal to a fourth threshold;
a difference between the Rx Timing or TOA of the target cell and a serving cell is less than or equal to a fifth threshold;
a multi-path distribution satisfies a first condition;
a related bandwidth is greater than or equal to a sixth threshold; or
a multi-antenna measurement result satisfies a second condition.

Or:

The preset condition includes at least one of the following:
a channel model is an NLOS;
a probability of an LOS is less than or equal to a second threshold;
an RSRP of a target cell is less than or equal to a seventh threshold;
an Rx Timing or TOA of the target cell is greater than or equal to an eighth threshold;
a difference between the Rx Timing or TOA of the target cell and a serving cell is greater than or equal to a ninth threshold;
a multi-path distribution does not satisfy a first condition;
a related bandwidth is less than or equal to a tenth threshold; or
a multi-antenna measurement result does not satisfy a second condition.

In this embodiment of this application, the operation that a target artificial intelligence network model and/or a target artificial intelligence network model parameter are indicated, configured or activated according to the first information includes:

The target artificial intelligence network model and/or the target artificial intelligence network model parameter are indicated, configured or activated in response to preset event being triggered.

In this embodiment of this application, the preset event includes a first preset event and a second preset event, and the operation that a target artificial intelligence network model and/or a target artificial intelligence network model parameter are indicated, configured or activated according to the first information includes:

The first target artificial intelligence network model and/or the first target artificial intelligence network model parameter are indicated, configured or activated in response to the first preset event being triggered.

The second target artificial intelligence network model and/or the second target artificial intelligence network model parameter are indicated, configured or activated in response to the second preset event being triggered.

In this embodiment of this application, the preset event includes at least one of the following:
1) Quality of Service (QOS) event.

For example, different QOS corresponds to different artificial intelligence network models.
2) Periodic event.
3) Event in which an absolute location variance is greater than or equal to an eleventh threshold.
4) Event in which a multi-measurement variance is greater than or equal to a twelfth threshold.
5) Radio Link Failure (RLF) event.
6) Radio Resource Management (RRM) event.

For example, the event is A1-A6 events.
7) Beam Failure (BF) event.

For example, beam failure detection is an event.
8) Beam Failure Recover (BFR) event.
9) Timing measurement.
10) Timing Advance (TA) measurement.
11) Event in which a Round Trip Time (RTT) measurement error or variance is excessive.
12) Event in which an Observed Time Difference of Arrival (OTDOA) measurement error or variance is excessive.

For example, different OTDOA intervals correspond to different conditions.
13) Event in which a Time Difference of Arrival (TDOA) measurement error or variance is excessive.
14) Event in which an RSRP measurement error or variance is excessive.
15) Event in which an RSRP measurement is lower than a thirteenth threshold.
16) Event in which a measurement error or variance of a reference terminal is excessive.
17) Report failure of a reference terminal.
18) Event in which a location error or variance of a reference terminal is excessive.

The location error may be an absolute location error or a relative location error.

In this embodiment of this application, the measurement error or variance of the reference terminal includes at least one of the following:
a timing or timing advance-based measurement error or variance;
a round trip event-based measurement error or variance;
an OTDOA-based measurement error or variance; For example, different OTDOA intervals correspond to different conditions.
a TDOA-based measurement error or variance;
an RSRP-based measurement error or variance; or
error information of the reference terminal, for example, an error between a computing location and a real location of the reference terminal.

In this embodiment of this application, the reference information of the reference terminal includes at least one of the following:
identification information of the reference terminal;
location information of the reference terminal;
measurement information of the reference terminal;
error information of the reference terminal;
an artificial intelligence network model used by the reference terminal; or
an artificial intelligence network model parameter used by the reference terminal.

In this embodiment of this application, the operation that a target artificial intelligence network model and/or a target artificial intelligence network model parameter are indicated, configured or activated according to the first information further includes:

The first target artificial intelligence network model and/or the first target artificial intelligence network model parameter are indicated, configured or activated in response to the environmental information being a first environment.

The second target artificial intelligence network model and/or the second target artificial intelligence network model parameter are indicated, configured or activated in response to the environmental information being a second environment.

In this embodiment of this application, the priority information includes at least one of the following:
preferential use of first-ranked artificial intelligence network models and/or artificial intelligence network model parameters;
preferential use of specified artificial intelligence network models and/or artificial intelligence network model parameters;
preferential use of associated artificial intelligence network models and/or artificial intelligence network model parameters;
preferential use of artificial intelligence network models and/or artificial intelligence network model parameters having small identifiers (Identifier, ID);
preferential use of artificial intelligence network models and/or artificial intelligence network model parameters having large IDs;
preferential use of artificial intelligence network models and/or artificial intelligence network model parameters having large data volume;
preferential use of artificial intelligence network models and/or artificial intelligence network model parameters having small data volume;
preferential use of artificial intelligence network models and/or artificial intelligence network model parameters having complex model structures;
preferential use of artificial intelligence network models and/or artificial intelligence network model parameters having simple model structures;
preferential use of artificial intelligence network models and/or artificial intelligence network model parameters having many model layers;
preferential use of artificial intelligence network models and/or artificial intelligence network model parameters having few model layers;
preferential use of artificial intelligence network models and/or artificial intelligence network model parameters having high quantification levels;
preferential use of artificial intelligence network models and/or artificial intelligence
preferential use of artificial intelligence network models and/or artificial intelligence network model parameters having fully connected neural network structures; or
preferential use of artificial intelligence network models and/or artificial intelligence network model parameters having convolutional neural network structures.

In this embodiment of this application, the location method further includes: The terminal reports capability information, where the capability information includes at least one of the following:
whether to support an artificial intelligence network model and/or an artificial intelligence network model parameter;
whether to support a plurality of artificial intelligence network models and/or a plurality of sets of artificial intelligence network model parameters; or
whether to support using an artificial intelligence network model and/or an artificial intelligence network model parameter to obtain or optimize positioning signal measurement information.

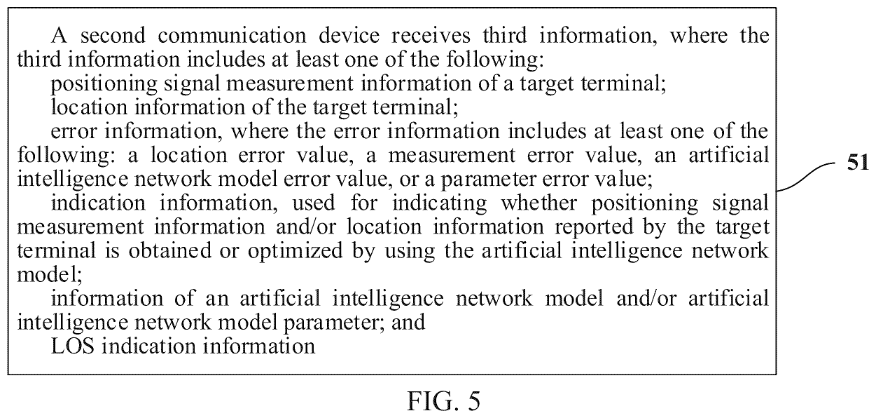

Referring to FIG. 5, embodiments of this application further provide a location method, including:

Step 51: A second communication device receives third information, where the third information includes at least one of the following:
positioning signal measurement information of a target terminal;
location information of the target terminal;
error information, where the error information includes at least one of the following:
a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of an artificial intelligence network model and/or artificial intelligence network model parameter; or
LOS indication information.

In some embodiments, the positioning signal measurement information of the target terminal includes at least one of the following:
channel response information of a positioning signal;
a reference signal time difference (RSTD) measurement result;
round trip time (RTT);
multi-round trip time;
an angle of arrival (AOA) measurement result;
an angle of departure (AOD) measurement result; or
reference signal received power (RSRP).

In some embodiments, the positioning signal measurement information is associated with or includes at least one piece of LOS indication information.

In some embodiments, the positioning signal measurement information includes at least one of the following:
angle information of a path;
time information of a path;
energy information of a path; or
LOS indication information.

In some embodiments, the LOS indication information is used for indicating one of the following:
an LOS condition between the target terminal and a target transmitting receiving point (TRP);
an LOS condition of the target terminal; or
an LOS condition between one or more location reference signal resources of the target terminal and a target TRP.

In some embodiments, the LOS indication information includes at least one of the following:
a first bit for indicating being an LOS or a non-line of sight (NLOS);
a second bit for indicating a probability of being an LOS; or
a third bit for indicating a confidence of being an LOS.

In some embodiments, the LOS indication information includes at least one of the following:
a first bit for indicating positioning signal measurement being an LOS or a non-line of sight (NLOS);
a second bit for indicating a probability of positioning signal measurement being an LOS; or
a third bit for indicating a confidence of positioning signal measurement being an LOS.

In some embodiments, the location method further includes: The second communication device receives associated information of LOS indication information reported by a first communication device, where the associated information includes at least one of the following:
an LOS confidence; or
second information for determining the LOS indication information.

In some embodiments, the second information includes at least one of the following:
a second artificial intelligence network model for determining the LOS indication information;
CIR;
power of first-path;
power of multi-path;
delay of first-path;
TOA of first-path;
RSTD of first-path;
delay of multi-path;
TOA of multi-path;
RSTD of multi-path;
angle of arrival of first-path;
angle of arrival of multi-path;
antenna subcarrier phase difference of first-path;
antenna subcarrier phase difference of multi-path;
average excess delay;
root mean square delay extension; or
coherent bandwidth.

In some embodiments, the location method further includes: The second communication device requests to report the second information.

In some embodiments, the location method further includes: The second communication device determines a third artificial intelligence network model or a third artificial intelligence network model parameter according to the third information and the second information.

The third artificial intelligence network model or the third artificial intelligence network model parameter is configured for a network side to obtain or optimize the positioning signal measurement information of the target terminal and/or the location information of the target terminal. Or, the third artificial intelligence network model or the third artificial intelligence network model parameter is transmitted to the target terminal to obtain or optimize the positioning signal measurement information of the target terminal and/or the location information of the target terminal.

Or, the second communication device transmits, according to the third information, an updated target artificial intelligence network model or artificial intelligence network model parameter to the terminal for adjusting a network model stored by the terminal.

Or, the second communication device transmits, according to the third information, a target artificial intelligence network model or artificial intelligence network model parameter for acquiring LOS indication information to the terminal.

In this embodiment of this application, the location method further includes: The second communication device receives capability information reported by a first communication device, where the capability information includes at least one of the following:
whether to support an artificial intelligence network model and/or an artificial intelligence network model parameter;
whether to support a plurality of artificial intelligence network models and/or a plurality of sets of artificial intelligence network model parameters; or
whether to support using an artificial intelligence network model and/or an artificial intelligence network model parameter to obtain or optimize positioning signal measurement information.

The location method of this application is supplemented below.

The artificial intelligence network model in this embodiment of this application includes one or more artificial intelligence network models, and/or one or more sets of artificial intelligence network model parameters.

The artificial intelligence network model in this embodiment of this application may be a machine learning model or a neural network model or a deep neural network model, including but not limited to:
a Convolutional Neural Network (CNN), such as googlenet and AlexNet;
a Recursive Neural Network (RNN) and a long short-term memory (LSTM);
a Recursive Neural Tensor Network (RNTN);
Generative Adversarial Networks (GAN);
Deep Belief Networks (DBN);
a Restricted Boltzmann Machine (RBM), and the like.

In this embodiment of this application, the artificial intelligence network model parameter includes a parameter of a machine learning model or a neural network model or a deep neural network model, including but not limited to at least one of the following: a weight, step size, mean, or variance of each layer.

In this embodiment of this application, input information of the artificial intelligence network model includes at least one of the following:
channel impulse response (CIR);
Power Delay Profile (PDP);
Reference Signal Time Difference (RSTD);
Round-trip Time (RTT);
Angle of Arrival (AoA);
RSRP;
TOA;
power of first-path;
power of multi-path;
delay of first-path;
TOA of first-path;
RSTD of first-path;
delay of multi-path;
TOA of multi-path;
RSTD of multi-path;
angle of arrival of first-path;
angle of arrival of multi-path;
antenna subcarrier phase difference of first-path;
antenna subcarrier phase difference of multi-path;
LoS/NLOS identification information;
average excess delay;
root mean square delay extension; or
coherent bandwidth, and the like.

In this embodiment of this application, the input information may be single-station or multi-station, and the single-station or multi-station information is determined by number information of base stations transmitted by a network side. The number of base stations includes 1-maxTRPNumber, where maxTRPNumber is a maximum number of TRPs in a specific scenario.

Output information of the artificial intelligence network model includes at least one of the following:
location coordinate information;
Reference Signal Time Difference (RSTD);
Round-trip Time (RTT);
Angle of Arrival (AoA);
RSRP;
TOA;
power of first-path;
power of multi-path;
delay of first-path;
time of arrival (TOA) of first-path;
reference signal time difference (RSTD) of first-path;
delay of multi-path;
TOA of multi-path;
RSTD of multi-path;
angle of arrival of first-path;
angle of arrival of multi-path; or
LoS/NLOS identification information.

The artificial intelligence network model in this embodiment of this application may further include: error model information for calibrating location, measurement, and artificial intelligence network model and/or parameter errors, including at least one of the following:
1) Error value estimated by network sides. Further, the error value includes at least one of the following: a location error value, a measurement error value, an artificial intelligence network model error value, or a parameter error value.
2) Error model estimated by one or more network sides. Further, the error model includes one of the following models: a location error model, a measurement error model, or a parameter error model.

The artificial intelligence network model in this embodiment of this application may further include: preprocessing model information for processing positioning signal measurement information of the terminal, including at least one of the following:
a filter parameter or structure;
a convolutional layer parameter or structure;
a pooling layer parameter or structure;
a Discrete Cosine Transform (DCT) parameter or structure;
a wavelet transform parameter or structure; or
a parameter or structure (for example, sampling, truncation, normalization,
simultaneous merging, and the like) of a positioning signal measurement information processing method.

In some embodiments, the positioning signal measurement information includes at least one of the following:
channel impulse response (CIR);
power delay profile;
Reference Signal Time Difference (RSTD);
Round-trip Time (RTT);
Angle of Arrival (AoA);
RSRP;
TOA;
power of first-path;
power of multi-path;
delay of first-path;
time of arrival (TOA) of first-path;
reference signal time difference (RSTD) of first-path;
delay of multi-path;
TOA of multi-path;
RSTD of multi-path;
angle of arrival of first-path;
angle of arrival of multi-path;
antenna subcarrier phase difference of first-path;
antenna subcarrier phase difference of multi-path;
reference signal waveform;
reference signal related sequence or the like.

In this embodiment of this application, the error model information and/or the preprocessing model information may be transmitted in association with an artificial intelligence network model for optimizing location information. Each artificial intelligence network model corresponds to error model information and/or preprocessing model information.

The execution entity of the location method provided by this embodiment of this application may be a location apparatus. In this embodiment of this application, the location apparatus provided by this embodiment of this application is explained with an example where the location apparatus performs the location method.

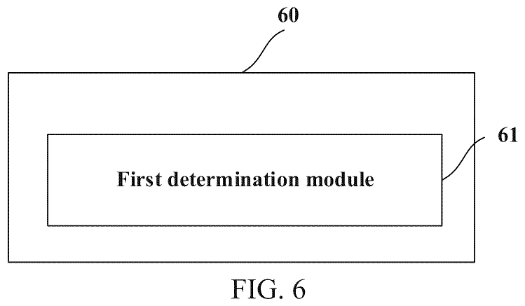

Referring to FIG. 6, embodiments of this application further provide a location apparatus 60, including:

a first determination module 61, configured to determine whether to use an artificial intelligence network model and/or an artificial intelligence network model parameter and/or determine an artificial intelligence network model and/or artificial intelligence network model parameter to be used according to first information, where the artificial intelligence network model is configured to obtain or optimize positioning signal measurement information of a target terminal and/or location information of the target terminal.

In this embodiment of this application, an artificial intelligence network model or an artificial intelligence network model parameter is used for obtaining or optimizing positioning signal measurement information of a target terminal and/or location information of the target terminal, thus reducing location errors and improving the accuracy of location results.

In some embodiments, the first information includes at least one of the following:
line of sight (LOS) indication information;
a preset condition;
a preset event;
configuration information, where the configuration information is used for configuring one or more artificial intelligence network models, and/or configuring one or more sets of artificial intelligence network model parameters, and/or indicating whether to use an artificial intelligence network model to obtain or optimize positioning signal measurement information of a target terminal and/or location information of the target terminal;
priority information, where the priority information is used for agreeing event, condition or cell-defaulted or initially-activated or preferentially-used artificial intelligence network models and/or artificial intelligence network model parameters;
environmental information of the target terminal;
reference information transmitted by a reference terminal;
positioning signal measurement information of the target terminal;
location information of the target terminal.

In some embodiments, the positioning signal measurement information of the target terminal includes at least one of the following:
channel response information of a positioning signal;
a reference signal time difference (RSTD) measurement result;
round trip time (RTT);
multi-round trip time;
an angle of arrival (AOA) measurement result;
an angle of departure (AOD) measurement result; or
reference signal received power (RSRP).

In some embodiments, the positioning signal measurement information is associated with or includes at least one piece of LOS indication information.

In some embodiments, the positioning signal measurement information includes positioning signal measurement information of at least one path.

In some embodiments, the positioning signal measurement information includes at least one of the following:
angle information of a path;
time information of a path;
energy information of a path; or
LOS indication information.

In some embodiments, the positioning signal measurement information of at least one path includes at least one piece of LOS indication information.

In some embodiments, the positioning signal measurement information of each path includes LOS indication information.

In some embodiments, the LOS indication information is used for indicating one of the following:
an LOS condition between the target terminal and a target transmitting receiving point (TRP);
an LOS condition of the target terminal; or
an LOS condition between one or more location reference signal resources of the target terminal and a target TRP.

In some embodiments, the LOS indication information includes at least one of the following:
a first bit for indicating being an LOS or a non-line of sight (NLOS);
a second bit for indicating a probability of being an LOS; or
a third bit for indicating a confidence of being an LOS.

In some embodiments, the LOS indication information includes at least one of the following:
a first bit for indicating positioning signal measurement being an LOS or a non-line of sight (NLOS);
a second bit for indicating a probability of positioning signal measurement being an LOS; or
a third bit for indicating a confidence of positioning signal measurement being an LOS.

In some embodiments, the location apparatus 60 further includes:
a second determination module, configured to determine LOS indication information based on a second artificial intelligence network model.

In some embodiments, the location apparatus 60 further includes:
a first report module, configured to report third information, where the third information includes at least one of the following:
positioning signal measurement information of the target terminal;
location information of the target terminal;
error information, where the error information includes at least one of the following: a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of the artificial intelligence network model and/or artificial intelligence network model parameter; or
LOS indication information.

In some embodiments, the location apparatus 60 further includes:
a second report module, configured to report associated information of the LOS indication information, where the associated information includes at least one of the following:
an LOS confidence; and
second information for determining the LOS indication information.

In some embodiments, the second information includes at least one of the following:
a second artificial intelligence network model for determining the LOS indication information;
channel impulse response (CIR);
power of first-path;
power of multi-path;
delay of first-path;
time of arrival (TOA) of first-path;
reference signal time difference (RSTD) of first-path;
delay of multi-path;
TOA of multi-path;
RSTD of multi-path;
angle of arrival of first-path;
angle of arrival of multi-path;
antenna subcarrier phase difference of first-path;
antenna subcarrier phase difference of multi-path;
average excess delay;
root mean square delay extension; and
coherent bandwidth.

In some embodiments, the artificial intelligence network model parameter includes at least one of the following:
a structure of the artificial intelligence network model;
a multiplicative coefficient, an additive coefficient, and/or an activation function of each neuron of the artificial intelligence network model;
complexity information of the artificial intelligence network model;
an expected training number of the artificial intelligence network model;
an application document of the artificial intelligence network model;
an input format of the artificial intelligence network model; and
an output format of the artificial intelligence network model.

In some embodiments, the first determination module is configured to indicate, configure or activate a target artificial intelligence network model and/or a target artificial intelligence network model parameter according to the first information.

In some embodiments, the first determination module is further configured to:
indicate, configure or activate a first target artificial intelligence network model and/or a first target artificial intelligence network model parameter in response to the LOS indication information indicating being an LOS;
indicate, configure or activate a second target artificial intelligence network model and/or a second target artificial intelligence network model parameter in response to the LOS indication information indicating being an NLOS;
indicate, configure or activate the first target artificial intelligence network model and/or the first target artificial intelligence network model parameter in response to that a probability of being an LOS indicated by the LOS indication information is greater than or equal to a first threshold; and
indicate, configure or activate the second target artificial intelligence network model and/or the second target artificial intelligence network model parameter in response to that a probability of being an LOS indicated by the LOS indication information is less than or equal to a second threshold.

In some embodiments, the first determination module is configured to indicate, configure or activate the target artificial intelligence network model and/or the target artificial intelligence network model parameter in response to satisfying a preset condition.

In some embodiments, the preset condition includes a first preset condition and a second preset condition, and the first determination module is configured to:
indicate, configure or activate the first target artificial intelligence network model and/or the first target artificial intelligence network model parameter in response to satisfying the first preset condition; and
indicate, configure or activate the second target artificial intelligence network model and/or the second target artificial intelligence network model parameter in response to satisfying the second preset condition.

In some embodiments, the preset condition includes at least one of the following:
a channel model is an LOS;
a probability of an LOS is greater than or equal to a first threshold;
an RSRP of a target cell is greater than or equal to a third threshold;
an Rx Timing or TOA of the target cell is less than or equal to a fourth threshold;
a difference between the Rx Timing or TOA of the target cell and a serving cell is less than or equal to a fifth threshold;
a multi-path distribution satisfies a first condition;
a related bandwidth is greater than or equal to a sixth threshold; and
a multi-antenna measurement result satisfies a second condition.

Or:

The preset condition includes at least one of the following:
a channel model is an NLOS;
a probability of an LOS is less than or equal to a second threshold;
an RSRP of a target cell is less than or equal to a seventh threshold;
an Rx Timing or TOA of the target cell is greater than or equal to an eighth threshold;
a difference between the Rx Timing or TOA of the target cell and a serving cell is greater than or equal to a ninth threshold;
a multi-path distribution does not satisfy a first condition;
a related bandwidth is less than or equal to a tenth threshold; and
a multi-antenna measurement result does not satisfy a second condition.

In some embodiments, the first determination module is configured to indicate, configure or activate the target artificial intelligence network model and/or the target artificial intelligence network model parameter in response to a preset event being triggered.

In some embodiments, the preset event includes a first preset event and a second preset event, and the first determination module is configured to:
indicate, configure or activate the first target artificial intelligence network model and/or the first target artificial intelligence network model parameter in response to the first preset event being triggered; and
indicate, configure or activate the second target artificial intelligence network model and/or the second target artificial intelligence network model parameter in response to the second preset event being triggered.

In some embodiments, the preset event includes at least one of the following:
a QoS event;
a periodic event;
an event in which an absolute location variance is greater than or equal to an eleventh threshold;
an event in which a multi-measurement variance is greater than or equal to a twelfth threshold;
a radio link failure (RLF) event;
a radio resource management (RRM) event;
a beam failure (BF) event;
a beam failure recover (BFR) event;
timing measurement;
timing advance (TA) measurement;
an event in which a round trip time (RTT) measurement error or variance is excessive;
an event in which an observed time difference of arrival (OTDOA) measurement error or variance is excessive;
an event in which a time difference of arrival (TDOA) measurement error or variance is excessive;
an event in which an RSRP measurement error or variance is excessive;
an event in which an RSRP measurement is lower than a thirteenth threshold;
an event in which a measurement error or variance of a reference terminal is excessive;
report failure of a reference terminal; and
an event in which a location error or variance of a reference terminal is excessive.

In some embodiments, the measurement error or variance of the reference terminal includes at least one of the following:
a timing or timing advance-based measurement error or variance;
a round trip event-based measurement error or variance;
an OTDOA-based measurement error or variance;
a TDOA-based measurement error or variance;
an RSRP-based measurement error or variance; and
error information of the reference terminal.

In some embodiments, the reference information of the reference terminal includes at least one of the following:
identification information of the reference terminal;
location information of the reference terminal;
measurement information of the reference terminal;
error information of the reference terminal;
an artificial intelligence network model used by the reference terminal; and
an artificial intelligence network model parameter used by the reference terminal.

In some embodiments, the first determination module is further configured to:
indicate, configure or activate the first target artificial intelligence network model and/or the first target artificial intelligence network model parameter in response to the environmental information being a first environment; and
indicate, configure or activate the second target artificial intelligence network model and/or the second target artificial intelligence network model parameter in response to the environmental information being a second environment.

In some embodiments, the priority information includes at least one of the following:
preferential use of first-ranked artificial intelligence network models and/or artificial intelligence network model parameters;
preferential use of specified artificial intelligence network models and/or artificial intelligence network model parameters;
preferential use of associated artificial intelligence network models and/or artificial intelligence network model parameters;
preferential use of artificial intelligence network models and/or artificial intelligence network model parameters having small identifiers (ID);
preferential use of artificial intelligence network models and/or artificial intelligence network model parameters having large IDs;
preferential use of artificial intelligence network models and/or artificial intelligence network model parameters having large data volume;
preferential use of artificial intelligence network models and/or artificial intelligence network model parameters having small data volume;
preferential use of artificial intelligence network models and/or artificial intelligence network model parameters having complex model structures;
preferential use of artificial intelligence network models and/or artificial intelligence network model parameters having simple model structures;
preferential use of artificial intelligence network models and/or artificial intelligence network model parameters having many model layers;
preferential use of artificial intelligence network models and/or artificial intelligence network model parameters having few model layers;
preferential use of artificial intelligence network models and/or artificial intelligence network model parameters having high quantification levels;
preferential use of artificial intelligence network models and/or artificial intelligence network model parameters having low quantification levels;
preferential use of artificial intelligence network models and/or artificial intelligence network model parameters having fully connected neural network structures; and
preferential use of artificial intelligence network models and/or artificial intelligence network model parameters having convolutional neural network structures.

In some embodiments, the location apparatus 60 further includes:
a third report module, configured to report capability information, where the capability information includes at least one of the following:
whether to support an artificial intelligence network model and/or an artificial intelligence network model parameter;
whether to support a plurality of artificial intelligence network models and/or a plurality of sets of artificial intelligence network model parameters; and
whether to support using an artificial intelligence network model and/or an artificial intelligence network model parameter to obtain or optimize positioning signal measurement information.

The location apparatus in this embodiment of this application may be an electronic device such as an electronic device having an operating system, or may be a component in an electronic device such as an integrated circuit or a chip. The electronic device may be a terminal or another device other than the terminal. Exemplarily, the terminal may include, but is not limited to, the type of the terminal 11 listed above, and the another device may be a server, a Network Attached Storage (NAS), or the like. This embodiment of this application is not specifically limited.

The location apparatus provided by this embodiment of this application can implement various processes in the method embodiments shown in FIG. 4, and the same technical effects can be achieved. To avoid repetition, details are omitted herein.

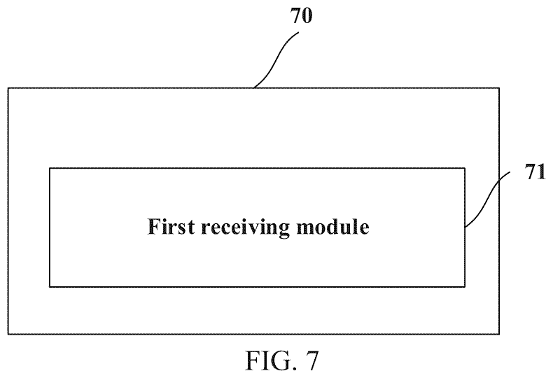

Referring to FIG. 7, embodiments of this application further provide a location apparatus 70, including:
a first receiving module 71, configured to receive third information, where the third information includes at least one of the following:
positioning signal measurement information of a target terminal;
location information of the target terminal;
error information, where the error information includes at least one of the following: a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of an artificial intelligence network model and/or artificial intelligence network model parameter; and
LOS indication information.

In some embodiments, the positioning signal measurement information of the target terminal includes at least one of the following:
channel response information of a positioning signal;
a reference signal time difference (RSTD) measurement result;
round trip time (RTT);
multi-round trip time;
an angle of arrival (AOA) measurement result;
an angle of departure (AOD) measurement result; and
reference signal received power (RSRP).

In some embodiments, the positioning signal measurement information is associated with or includes at least one piece of LOS indication information.

In some embodiments, the positioning signal measurement information includes at least one of the following:
angle information of a path;
time information of a path;
energy information of a path; and
LOS indication information.

In some embodiments, the LOS indication information is used for indicating one of the following:
an LOS condition between the target terminal and a target transmitting receiving point (TRP);
an LOS condition of the target terminal; and
an LOS condition between one or more location reference signal resources of the target terminal and a target TRP.

In some embodiments, the LOS indication information includes at least one of the following:
a first bit for indicating being an LOS or a non-line of sight (NLOS);
a second bit for indicating a probability of being an LOS; and
a third bit for indicating a confidence of being an LOS.

In some embodiments, the LOS indication information includes at least one of the following:
a first bit for indicating positioning signal measurement being an LOS or a non-line of sight (NLOS);
a second bit for indicating a probability of positioning signal measurement being an LOS; and
a third bit for indicating a confidence of positioning signal measurement being an LOS.

In some embodiments, the location apparatus 70 further includes:
a second receiving module, configured to receive associated information of LOS indication information reported by a first communication device, where the associated information includes at least one of the following:
an LOS confidence; and
second information for determining the LOS indication information.

In some embodiments, the second information includes at least one of the following:
a second artificial intelligence network model for determining the LOS indication information;
channel impulse response (CIR);
power of first-path;
power of multi-path;
delay of first-path;
time of arrival (TOA) of first-path;
reference signal time difference (RSTD) of first-path;
delay of multi-path;
TOA of multi-path;
RSTD of multi-path;
angle of arrival of first-path;
angle of arrival of multi-path;
antenna subcarrier phase difference of first-path;
antenna subcarrier phase difference of multi-path;
average excess delay;
root mean square delay extension; and
coherent bandwidth.

In some embodiments, the location apparatus 70 further includes:
a request module, configured to request to report the second information.

In some embodiments, the location apparatus 70 further includes:
a determination module, configured to: determine a third artificial intelligence network model or a third artificial intelligence network model parameter according to the third information and the second information,
where the third artificial intelligence network model or the third artificial intelligence network model parameter is configured for a network side to obtain or optimize the positioning signal measurement information of the target terminal and/or the location information of the target terminal; or, transmit the third artificial intelligence network model or the third artificial intelligence network model parameter to the target terminal to obtain or optimize the positioning signal measurement information of the target terminal and/or the location information of the target terminal.

In some embodiments, the location apparatus 70 further includes:
a third receiving module, configured to receive capability information reported by the first communication device, where the capability information includes at least one of the following:
whether to support an artificial intelligence network model and/or an artificial intelligence network model parameter;
whether to support a plurality of artificial intelligence network models and/or a plurality of sets of artificial intelligence network model parameters; and
whether to support using an artificial intelligence network model and/or an artificial intelligence network model parameter to obtain or optimize positioning signal measurement information.

The location apparatus provided by this embodiment of this application can implement various processes in the method embodiments shown in FIG. 5, and the same technical effects can be achieved. To avoid repetition, details are omitted herein.

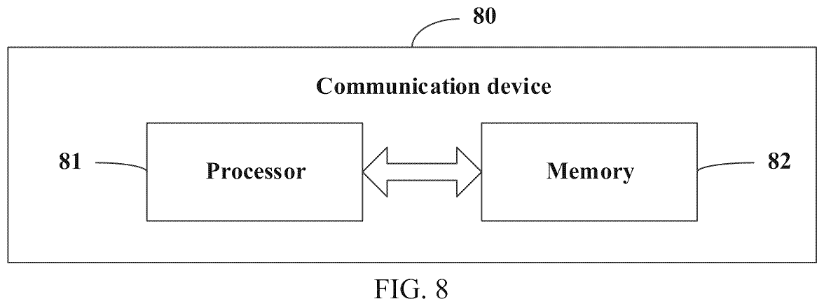

As shown in FIG. 8, embodiments of this application further provide a communication device 80, including a processor 81 and a memory 82. The memory 82 stores programs or instructions executable on the processor 81. For example, when the communication device 80 is a terminal, the programs or instructions, when executed by the processor 81, implement various steps of the embodiments of the location method performed by a terminal, and the same technical effects can be achieved. When the communication device 80 is a network-side device, the programs or instructions, when executed by the processor 81, implement various steps of the embodiments of the location method performed by the network-side device, and the same technical effects can be achieved. To avoid repetition, details are omitted herein.

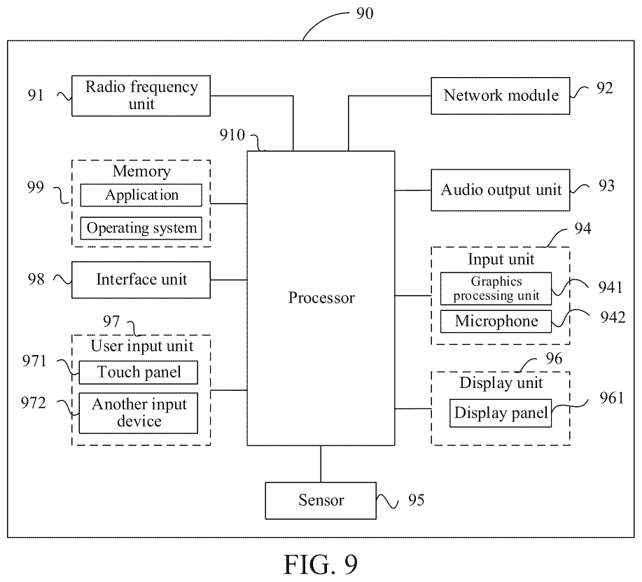

Embodiments of this application further provide a terminal, including a processor and a communication interface. The processor is configured to determine whether to use an artificial intelligence network model and/or an artificial intelligence network model parameter and/or determine an artificial intelligence network model and/or artificial intelligence network model parameter to be used according to first information. The artificial intelligence network model is configured to obtain or optimize positioning signal measurement information of a target terminal and/or location information of the target terminal. The terminal embodiments correspond to the foregoing terminal-side method embodiments. Each implementation process and implementation mode of the foregoing method embodiments may be applied to the terminal embodiments, and can achieve the same technical effect. FIG. 9 is a schematic diagram depicting a hardware structure of a terminal according to embodiments of this application.

The terminal 90 includes, but is not limited to, at least some components such as a radio frequency unit 91, a network module 92, an audio output unit 93, an input unit 94, a sensor 95, a display unit 96, a user input unit 97, an interface unit 98, a memory 99, and a processor 910.

It will be appreciated by those skilled in the art that the terminal 90 may further include a power supply (such as a battery) for supplying power to the components. The power supply may be logically connected to the processor 910 by a power management system, thereby implementing functions such as charging, discharging, and power consumption management by using the power management system. The terminal structure shown in FIG. 9 does not constitute a limitation on the terminal, and the terminal may include more or fewer components than shown, or combine some components, or have different component arrangements. Details are omitted herein.

It will be understood that in this embodiment of this application, the input unit 94 may include a Graphics Processing Unit (GPU) 941 and a microphone 942. The graphics processing unit 941 performs processing on image data of a static picture or a video that is obtained by an image capture apparatus (for example, a camera) in a video capture mode or an image capture mode. The display unit 96 may include a display panel 961. The display panel 961 may be configured by using a liquid crystal display, an organic light-emitting diode, or the like. The user input unit 97 includes at least one of a touch panel 971 and another input device 972. The touch panel 971 may also be referred to as a touch screen. The touch panel 971 may include two parts: a touch detection apparatus and a touch controller. The another input device 972 may include, but is not limited to, a physical keyboard, a functional key (such as a volume control key or a switch key), a track ball, a mouse, and a joystick. Details are omitted herein.

In this embodiment of this application, the radio frequency unit 91 receives downlink data from a network-side device and may then transmit the downlink data to the processor 910 for processing. In addition, the radio frequency unit 91 may transmit uplink data to the network-side device. Generally, the radio frequency unit 91 includes, but is not limited to, an antenna, an amplifier, a transceiver, a coupler, a low noise amplifier, a duplexer, and the like.

The memory 99 may be configured to store software programs or instructions and various data. The memory 99 may mainly include a first storage area for storing programs or instructions and a second storage area for storing data. The first storage area may store an operating system, an application or instruction required by at least one function (such as a sound playback function and an image display function), and the like. Furthermore, the memory 99 may include a volatile memory or a non-volatile memory, or the memory 99 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 99 in this embodiment of this application includes, but is not limited to, these memories and any other suitable types of memories.

The processor 910 may include one or more processing units. In some embodiments, the processor 910 integrates an application processor and a modem processor. The application processor mainly processes operations involving an operating system, a user interface, and an application. The modem processor such as a baseband processor mainly processes wireless communication signals. It will be understood that the foregoing modem may either not be integrated into the processor 910.

The processor 910 is configured to determine whether to use an artificial intelligence network model and/or an artificial intelligence network model parameter and/or determine an artificial intelligence network model and/or artificial intelligence network model parameter to be used according to first information, where the artificial intelligence network model is configured to obtain or optimize positioning signal measurement information of a target terminal and/or location information of the target terminal.

In this embodiment of this application, a terminal uses an artificial intelligence network model or an artificial intelligence network model parameter to obtain or optimize positioning signal measurement information of a target terminal and/or location information of the target terminal, thus reducing location errors and improving the accuracy of location results.

In some embodiments, the first information includes at least one of the following:
LOS indication information;
a preset condition;
a preset event;
configuration information, where the configuration information is used for configuring one or more artificial intelligence network models, and/or configuring one or more sets of artificial intelligence network model parameters, and/or indicating whether to use an artificial intelligence network model to obtain or optimize positioning signal measurement information of a target terminal and/or location information of the target terminal;
priority information, where the priority information is used for agreeing event, condition or cell-defaulted or initially-activated or preferentially-used artificial intelligence network models and/or artificial intelligence network model parameters;
environmental information of the terminal;
reference information transmitted by a reference terminal;
positioning signal measurement information of the target terminal; and
location information of the target terminal.

In some embodiments, the positioning signal measurement information of the target terminal includes at least one of the following:
channel response information of a positioning signal;
a reference signal time difference (RSTD) measurement result;
round trip time (RTT);
multi-round trip time;
an angle of arrival (AOA) measurement result;
an angle of departure (AOD) measurement result; and
reference signal received power (RSRP).

In some embodiments, the positioning signal measurement information is associated with or includes at least one piece of LOS indication information.

In some embodiments, the positioning signal measurement information includes positioning signal measurement information of at least one path.

In some embodiments, the positioning signal measurement information includes at least one of the following:
angle information of a path;
time information of a path;
energy information of a path; and
LOS indication information.

In some embodiments, the positioning signal measurement information of at least one path includes at least one piece of LOS indication information.

In some embodiments, the positioning signal measurement information of each path includes LOS indication information.

In some embodiments, the LOS indication information is used for indicating one of the following:
an LOS condition between the target terminal and a target transmitting receiving point (TRP);
an LOS condition of the target terminal; and
an LOS condition between one or more location reference signal resources of the target terminal and a target TRP.

In some embodiments, the LOS indication information includes at least one of the following:
a first bit for indicating being an LOS or a non-line of sight (NLOS);
a second bit for indicating a probability of being an LOS; and
a third bit for indicating a confidence of being an LOS.

In some embodiments, the LOS indication information includes at least one of the following:
a first bit for indicating positioning signal measurement being an LOS or a non-line of sight (NLOS);
a second bit for indicating a probability of positioning signal measurement being an LOS; and
a third bit for indicating a confidence of positioning signal measurement being an LOS.

In some embodiments, the processor 910 is further configured to determine LOS indication information based on a second artificial intelligence network model.

In some embodiments, the radio frequency unit 91 is further configured to report third information, where the third information includes at least one of the following:
positioning signal measurement information of the target terminal;
location information of the target terminal;
error information, where the error information includes at least one of the following:

a location error value, a measurement error value, an artificial intelligence network model error value, or a parameter error value;
indication information, used for indicating whether positioning signal measurement information and/or location information reported by the target terminal is obtained or optimized by using the artificial intelligence network model;
information of the artificial intelligence network model and/or artificial intelligence network model parameter; and
LOS indication information.

In some embodiments, the radio frequency unit 91 is configured to report associated information of the LOS indication information, where the associated information includes at least one of the following:
an LOS confidence; and
second information for determining the LOS indication information.

In some embodiments, the second information includes at least one of the following:
a second artificial intelligence network model for determining the LOS indication information;
channel impulse response (CIR);
power of first-path;
power of multi-path;
delay of first-path;
time of arrival (TOA) of first-path;
reference signal time difference (RSTD) of first-path;
delay of multi-path;
TOA of multi-path;
RSTD of multi-path;
angle of arrival of first-path;
angle of arrival of multi-path;
antenna subcarrier phase difference of first-path;
antenna subcarrier phase difference of multi-path;
average excess delay;
root mean square delay extension; and
coherent bandwidth.

In some embodiments, the artificial intelligence network model parameter includes
at least one of the following:
a structure of the artificial intelligence network model;
a multiplicative coefficient, an additive coefficient, and/or an activation function of each neuron of the artificial intelligence network model;
complexity information of the artificial intelligence network model;
an expected training number of the artificial intelligence network model;
an application document of the artificial intelligence network model;
an input format of the artificial intelligence network model; and
an output format of the artificial intelligence network model.
In some embodiments, the processor 910 is configured to indicate, configure or activate a target artificial intelligence network model and/or a target artificial intelligence network model parameter according to the first information.

In some embodiments, the processor 910 is configured to:
indicate, configure or activate a first target artificial intelligence network model and/or a first target artificial intelligence network model parameter in response to the LOS indication information indicating being an LOS;
indicate, configure or activate a second target artificial intelligence network model and/or a second target artificial intelligence network model parameter in response to the LOS indication information indicating being an NLOS;
indicate, configure or activate the first target artificial intelligence network model and/or the first target artificial intelligence network model parameter in response to that a probability of being an LOS indicated by the LOS indication information is greater than or equal to a first threshold; and
indicate, configure or activate the second target artificial intelligence network model and/or the second target artificial intelligence network model parameter in response to that a probability of being an LOS indicated by the LOS indication information is less than or equal to a second threshold.

In some embodiments, the preset condition includes a first preset condition and a second preset condition, and the processor 910 is configured to:
indicate, configure or activate the first target artificial intelligence network model and/or the first target artificial intelligence network model parameter in response to satisfying the first preset condition; and
indicate, configure or activate the second target artificial intelligence network model and/or the second target artificial intelligence network model parameter in response to satisfying the second preset condition.

In some embodiments, the preset condition includes at least one of the following: a channel model is an LOS;
a probability of an LOS is greater than or equal to a first threshold;
an RSRP of a target cell is greater than or equal to a third threshold;
an Rx Timing or TOA of the target cell is less than or equal to a fourth threshold;
a difference between the Rx Timing or TOA of the target cell and a serving cell is less than or equal to a fifth threshold;
a multi-path distribution satisfies a first condition;
a related bandwidth is greater than or equal to a sixth threshold; and
a multi-antenna measurement result satisfies a second condition.

Or:

The preset condition includes at least one of the following:
a channel model is an NLOS;
a probability of an LOS is less than or equal to a second threshold;
an RSRP of a target cell is less than or equal to a seventh threshold;
an Rx Timing or TOA of the target cell is greater than or equal to an eighth threshold;
a difference between the Rx Timing or TOA of the target cell and a serving cell is greater than or equal to a ninth threshold;
a multi-path distribution does not satisfy a first condition;
a related bandwidth is less than or equal to a tenth threshold; and
a multi-antenna measurement result does not satisfy a second condition.

In some embodiments, the preset event includes a first preset event and a second preset event, and the processor 910 is configured to:
indicate, configure or activate the first target artificial intelligence network model and/or the first target artificial intelligence network model parameter in response to the first preset event being triggered; and
indicate, configure or activate the second target artificial intelligence network model and/or the second target artificial intelligence network model parameter in response to the second preset event being triggered.

In some embodiments, the preset event includes at least one of the following:
a QoS event;
a periodic event;
an event in which an absolute location variance is greater than or equal to an eleventh threshold;
an event in which a multi-measurement variance is greater than or equal to a twelfth threshold;
a radio link failure (RLF) event;
a radio resource management (RRM) event;
a beam failure (BF) event;
a beam failure recover (BFR) event;
timing measurement;
timing advance (TA) measurement;
an event in which a round trip time (RTT) measurement error or variance is excessive;
an event in which an observed time difference of arrival (OTDOA) measurement error or variance is excessive;
an event in which a time difference of arrival (TDOA) measurement error or variance is excessive;
an event in which an RSRP measurement error or variance is excessive;
an event in which an RSRP measurement is lower than a thirteenth threshold;
an event in which a measurement error or variance of a reference terminal is excessive;
report failure of a reference terminal; and
an event in which a location error or variance of a reference terminal is excessive.

In some embodiments, the measurement error or variance of the reference terminal includes at least one of the following:
a timing or timing advance-based measurement error or variance;
a round trip event-based measurement error or variance;
an OTDOA-based measurement error or variance;
a TDOA-based measurement error or variance;
an RSRP-based measurement error or variance; and
error information of the reference terminal.

In some embodiments, the reference information of the reference terminal includes at least one of the following:
identification information of the reference terminal;
location information of the reference terminal;
measurement information of the reference terminal;
error information of the reference terminal;
an artificial intelligence network model used by the reference terminal; and
an artificial intelligence network model parameter used by the reference terminal.

In some embodiments, the processor 910 is configured to:
indicate, configure or activate the first target artificial intelligence network model and/or the first target artificial intelligence network model parameter in response to the environmental information being a first environment; and
indicate, configure or activate the second target artificial intelligence network model and/or the second target artificial intelligence network model parameter in response to the environmental information being a second environment.

In some embodiments, the priority information includes at least one of the following:
preferential use of first-ranked artificial intelligence network models and/or artificial intelligence network model parameters;
preferential use of specified artificial intelligence network models and/or artificial intelligence network model parameters;
preferential use of associated artificial intelligence network models and/or artificial intelligence network model parameters;
preferential use of artificial intelligence network models and/or artificial intelligence network model parameters having small identifiers (ID);
preferential use of artificial intelligence network models and/or artificial intelligence network model parameters having large IDs;
preferential use of artificial intelligence network models and/or artificial intelligence network model parameters having large data volume;
preferential use of artificial intelligence network models and/or artificial intelligence network model parameters having small data volume;
preferential use of artificial intelligence network models and/or artificial intelligence network model parameters having complex model structures;
preferential use of artificial intelligence network models and/or artificial intelligence network model parameters having simple model structures;
preferential use of artificial intelligence network models and/or artificial intelligence network model parameters having many model layers;
preferential use of artificial intelligence network models and/or artificial intelligence network model parameters having few model layers;
preferential use of artificial intelligence network models and/or artificial intelligence network model parameters having high quantification levels;
preferential use of artificial intelligence network models and/or artificial intelligence
preferential use of artificial intelligence network models and/or artificial intelligence network model parameters having fully connected neural network structures; and
preferential use of artificial intelligence network models and/or artificial intelligence network model parameters having convolutional neural network structures.

In some embodiments, the radio frequency unit 91 is configured to report capability information, where the capability information includes at least one of the following:
whether to support an artificial intelligence network model and/or an artificial intelligence network model parameter;
whether to support a plurality of artificial intelligence network models and/or a plurality of sets of artificial intelligence network model parameters; and
whether to support using an artificial intelligence network model and/or an artificial intelligence network model parameter to obtain or optimize positioning signal measurement information.

Embodiments of this application further provide a communication device, including a processor and a communication interface. The communication interface is configured to receive third information. The third information includes at least one of the following:
positioning signal measurement information of a terminal;
location information of the terminal;
error information, where the error information includes at least one of the following: a location error value, a measurement error value, an artificial intelligence network model error value, or a parameter error value; and
indication information, used for indicating whether positioning signal measurement information and/or location information reported by the terminal is obtained or optimized by using the artificial intelligence network model.

The communication device embodiments correspond to the foregoing method embodiments performed by the second communication device. Each implementation process and implementation mode of the foregoing method embodiments may be applied to the communication device embodiments, and the same technical effects can be achieved.

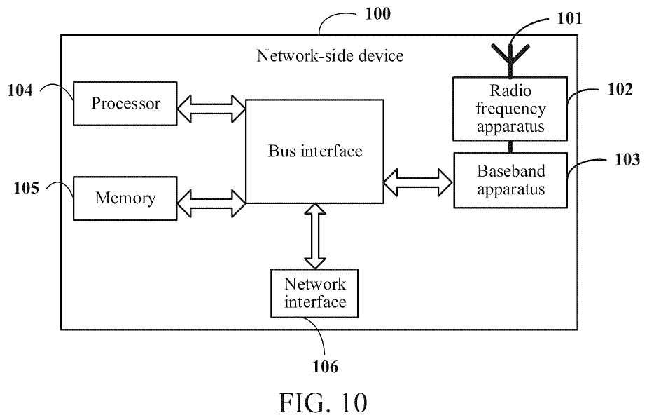

Embodiments of this application further provide a network-side device. As shown in FIG. 10, a network-side device 100 includes: an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101 and transmits the received information to the baseband apparatus 103 for processing. In a downlink direction, the baseband apparatus 103 processes information to be transmitted and transmits the information to the radio frequency apparatus 102. The radio frequency apparatus 102 processes the received information and transmits the information through the antenna 101.

The method performed by the network-side device in the above embodiments may be implemented in the baseband apparatus 103. The baseband apparatus 103 includes a baseband processor.

The baseband apparatus 103 may, for example, include at least one baseband board. The baseband board is provided with a plurality of chips. As shown in FIG. 10, one of the chips is, for example, the baseband processor, connected to the memory 105 through a bus interface to invoke programs in the memory 105 to perform a network device operation shown in the above method embodiments.

The network-side device may further include a network interface 106. The interface is, for example, a common public radio interface (CPRI).

The network-side device 100 in this embodiment of the present application further includes: instructions or programs stored in the memory 105 and executable on the processor 104. The processor 104 invokes the instructions or programs in the memory 105 to implement the method performed by each module shown in FIG. 7, and the same technical effects can be achieved. To avoid repetition, details are omitted herein.

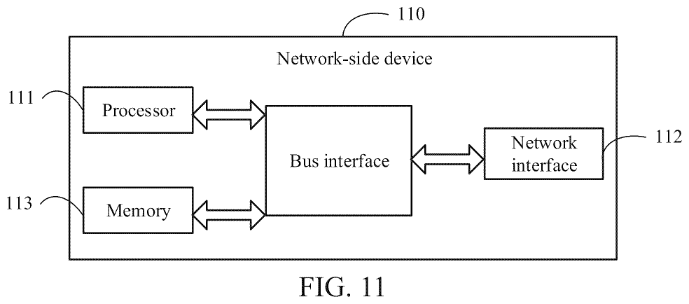

Embodiments of this application further provide a network-side device. As shown in FIG. 11, a network-side device 110 includes: a processor 111, a network interface 112, and a memory 113. The network interface 112 is, for example, a common public radio interface (CPRI).

The network-side device 110 in this embodiment of the present application further includes: instructions or programs stored in the memory 113 and executable on the processor 111. The processor 111 invokes the instructions or programs in the memory 113 to implement the method performed by each module shown in FIG. 7, and the same technical effects can be achieved. To avoid repetition, details are omitted herein.

Embodiments of this application further provide a readable storage medium. The storage medium may be volatile or non-volatile. The readable storage medium stores programs or instructions. The programs or instructions, when executed by a processor, implement various processes of the embodiments of the location method, and the same technical effects can be achieved. To avoid repetition, details are omitted herein.

The processor is a processor in the terminal described in the foregoing embodiments. The readable storage medium includes a computer-readable storage medium, such as a computer read-only memory (ROM), a random access memory (RAM), a magnetic disk, an optical disc, or the like.

Embodiments of this application additionally provide a chip. The chip includes a processor and a communication interface. The communication interface is coupled to the processor. The processor is configured to execute programs or instructions, which implement various processes of the embodiments of the location method, and the same technical effects can be achieved. To avoid repetition, details are omitted herein.

It should be understood that the chip referred to in this embodiment of this application may also be referred to as a system-on-chip, a system chip, a chip system, a system-on-a-chip, or the like.

Embodiments of this application additionally provide a computer program product. The computer program product is stored in a storage medium. The computer program product is executed by at least one processor to implement various processes of the embodiments of the location method, and the same technical effects can be achieved. To avoid repetition, details are omitted herein.

It should be noted that the terms “include”, “comprise”, or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, elements defined by the sentence “including one” does not exclude that there are still other same elements in the processes, methods, objects, or apparatuses. Furthermore, it should be noted that the scope of the method and apparatus in the implementations of this application is not limited to performing functions in the order shown or discussed, but may also include performing functions in a substantially simultaneous manner or in reverse order depending on the functions involved. For example, the described methods may be performed in a different order than described, and various steps may be added, omitted, or combined. In addition, features described with reference to some examples may be combined in other examples.

According to the descriptions in the above implementations, those skilled in the art may clearly learn that the method according to the foregoing embodiment may be implemented by relying on software and a necessary common hardware platform, and may be definitely implemented by hardware. Based on such an understanding, the technical solution of this application, either inherently or in any part contributing to the related art, may be embodied in the form of a computer software product. The computer software product is stored in a storage medium (such as a ROM/RAM, a magnetic disk, and an optical disc), and includes a plurality of instructions for enabling a terminal (which may be a mobile phone, a computer, a server, an air conditioner, or a network device) to perform the method according to the various embodiments of this application.

Embodiments of this application have been described above with reference to the accompanying drawings. However, this application is not limited to the specific implementations described above, and the specific implementations described above are merely exemplary and not limitative. Those of ordinary skill in the art may make various variations under the teaching of this application without departing from the spirit of this application and the protection scope of the claims, and such variations all fall within the protection scope of this application.

What is claimed is:

1. A location method, comprising:
determining, by a first communication device, whether to use an artificial intelligence network model or an artificial intelligence network model parameter or determining an artificial intelligence network model or artificial intelligence network model parameter to be used according to first information, wherein the artificial intelligence network model is configured to obtain or optimize positioning signal measurement information of a target terminal or location information of the target terminal.

2. The location method according to claim 1, wherein the first information comprises at least one of the following:
line of sight (LOS) indication information;
a preset condition;
a preset event;
configuration information, wherein the configuration information is used for configuring one or more artificial intelligence network models, or configuring one or more sets of artificial intelligence network model parameters, or indicating whether to use an artificial intelligence network model to obtain or optimize positioning signal measurement information of a target terminal or location information of the target terminal;
priority information, wherein the priority information is used for agreeing event, condition or cell-defaulted or initially-activated or preferentially-used artificial intelligence network models or artificial intelligence network model parameters;
environmental information of the target terminal;
reference information transmitted by a reference terminal;
positioning signal measurement information of the target terminal; or
location information of the target terminal.

3. The location method according to claim 1, wherein the positioning signal measurement information of the target terminal comprises at least one of the following:
channel response information of a positioning signal;
a reference signal time difference (RSTD) measurement result;
round trip time (RTT);
multi-round trip time;
an angle of arrival (AOA) measurement result;
an angle of departure (AOD) measurement result; or
reference signal received power (RSRP).

4. The location method according to claim 2, wherein the positioning signal measurement information is associated with or comprises at least one piece of LOS indication information.

5. The location method according to claim 2, wherein the positioning signal measurement information comprises positioning signal measurement information of at least one path; or
the positioning signal measurement information comprises at least one of the following:
angle information of a path;
time information of a path;
energy information of a path; or
LOS indication information.

6. The location method according to claim 2, wherein the LOS indication information is used for indicating one of the following:
an LOS condition between the target terminal and a target transmitting receiving point (TRP);
an LOS condition of the target terminal; or
an LOS condition between one or more location reference signal resources of the target terminal and a target TRP.

7. The location method according to claim 2, wherein the LOS indication information comprises at least one of the following:
a first bit for indicating being an LOS or a non-line of sight (NLOS);
a second bit for indicating a probability of being an LOS; or
a third bit for indicating a confidence of being an LOS.

8. The location method according to claim 2, wherein the determining, by a first communication device, an artificial intelligence network model or an artificial intelligence network model parameter according to first information further comprises:
determining, by the terminal, LOS indication information based on a second artificial intelligence network model.

9. The location method according to claim 1, wherein after the determining, by a first communication device, an artificial intelligence network model or artificial intelligence network model parameter to be used according to first information, the method further comprises:
reporting, by the first communication device, third information, wherein the third information comprises at least one of the following:
positioning signal measurement information of the target terminal;
location information of the target terminal;
error information, wherein the error information comprises at least one of the following: a location error value, a measurement error value, an artificial intelligence network model error value, or a parameter error value;
indication information, used for indicating whether positioning signal measurement information or location information reported by the target terminal is obtained or optimized by using the artificial intelligence network model;
information of the artificial intelligence network model or artificial intelligence network model parameter; or
LOS indication information.

10. The location method according to claim 9, further comprising:
reporting, by the first communication device, associated information of the LOS indication information, wherein the associated information comprises at least one of the following:
an LOS confidence; or
second information for determining the LOS indication information.

11. The location method according to claim 1, wherein the artificial intelligence network model parameter comprises at least one of the following:
a structure of the artificial intelligence network model;
a multiplicative coefficient, an additive coefficient, or an activation function of each neuron of the artificial intelligence network model;
complexity information of the artificial intelligence network model;
an expected training number of the artificial intelligence network model;
an application document of the artificial intelligence network model;
an input format of the artificial intelligence network model; or
an output format of the artificial intelligence network model.

12. The location method according to claim 2, wherein the determining, by a first communication device, an artificial intelligence network model or artificial intelligence network model parameter to be used according to first information comprises:
indicating, configuring or activating, by the first communication device, a target artificial intelligence network model or a target artificial intelligence network model parameter according to the first information.

13. The location method according to claim 12, wherein the indicating, configuring or activating, by the first communication device, a target artificial intelligence network model or a target artificial intelligence network model parameter according to the first information comprises one of the following:
indicating, configuring or activating, by the first communication device, a first target artificial intelligence network model or a first target artificial intelligence network model parameter in response to the LOS indication information indicating being an LOS;
indicating, configuring or activating, by the first communication device, a second target artificial intelligence network model or a second target artificial intelligence network model parameter in response to the LOS indication information indicating being an NLOS;
indicating, configuring or activating, by the first communication device, the first target artificial intelligence network model or the first target artificial intelligence network model parameter in response to that a probability of being an LOS indicated by the LOS indication information is greater than or equal to a first threshold; or
indicating, configuring or activating, by the first communication device, the second target artificial intelligence network model or the second target artificial intelligence network model parameter in response to that a probability of being an LOS indicated by the LOS indication information is less than or equal to a second threshold.

14. The location method according to claim 2, wherein
the preset condition comprises at least one of the following:
a channel model is an LOS;
a probability of an LOS is greater than or equal to a first threshold;
an RSRP of a target cell is greater than or equal to a third threshold;
an Rx Timing or TOA of the target cell is less than or equal to a fourth threshold;
a difference between the Rx Timing or TOA of the target cell and a serving cell is less than or equal to a fifth threshold;
a multi-path distribution satisfies a first condition;
a related bandwidth is greater than or equal to a sixth threshold; or
a multi-antenna measurement result satisfies a second condition;
or,
the preset condition comprises at least one of the following:
a channel model is an NLOS;
a probability of an LOS is less than or equal to a second threshold;
an RSRP of a target cell is less than or equal to a seventh threshold;
an Rx Timing or TOA of the target cell is greater than or equal to an eighth threshold;
a difference between the Rx Timing or TOA of the target cell and a serving cell is greater than or equal to a ninth threshold;
a multi-path distribution does not satisfy a first condition;
a related bandwidth is less than or equal to a tenth threshold; or
a multi-antenna measurement result does not satisfy a second condition.

15. The location method according to claim 2, wherein the preset event comprises at least one of the following:
a quality of service (QOS) event;
a periodic event;
an event in which an absolute location variance is greater than or equal to an eleventh threshold;
an event in which a multi-measurement variance is greater than or equal to a twelfth threshold;
a radio link failure (RLF) event;
a radio resource management (RRM) event;
a beam failure (BF) event;
a beam failure recover (BFR) event;
timing measurement;
timing advance (TA) measurement;
an event in which a round trip time (RTT) measurement error or variance is excessive;
an event in which an observed time difference of arrival (OTDOA) measurement error or variance is excessive;
an event in which a time difference of arrival (TDOA) measurement error or variance is excessive;
an event in which an RSRP measurement error or variance is excessive;
an event in which an RSRP measurement is lower than a thirteenth threshold;
an event in which a measurement error or variance of a reference terminal is excessive;
report failure of a reference terminal; or
an event in which a location error or variance of a reference terminal is excessive.

16. The location method according to claim 2, wherein the reference information of the reference terminal comprises at least one of the following:
identification information of the reference terminal;
location information of the reference terminal;
measurement information of the reference terminal;
error information of the reference terminal;
an artificial intelligence network model used by the reference terminal; or
an artificial intelligence network model parameter used by the reference terminal.

17. The location method according to claim 2, wherein the priority information comprises at least one of the following:
preferential use of first-ranked artificial intelligence network models or artificial intelligence network model parameters;
preferential use of specified artificial intelligence network models or artificial intelligence network model parameters;
preferential use of associated artificial intelligence network models or artificial intelligence network model parameters;
preferential use of artificial intelligence network models or artificial intelligence network model parameters having small identifiers (ID);
preferential use of artificial intelligence network models or artificial intelligence network model parameters having large IDs;
preferential use of artificial intelligence network models or artificial intelligence network model parameters having large data volume;
preferential use of artificial intelligence network models or artificial intelligence network model parameters having small data volume;
preferential use of artificial intelligence network models or artificial intelligence network model parameters having complex model structures;
preferential use of artificial intelligence network models or artificial intelligence network model parameters having simple model structures;
preferential use of artificial intelligence network models or artificial intelligence network model parameters having many model layers;
preferential use of artificial intelligence network models or artificial intelligence network model parameters having few model layers;
preferential use of artificial intelligence network models or artificial intelligence network model parameters having high quantification levels;
preferential use of artificial intelligence network models or artificial intelligence network model parameters having low quantification levels;
preferential use of artificial intelligence network models or artificial intelligence network model parameters having fully connected neural network structures; or
preferential use of artificial intelligence network models or artificial intelligence network model parameters having convolutional neural network structures.

18. The location method according to claim 1, further comprising:
reporting, by the first communication device, capability information, wherein the capability information comprises at least one of the following:
whether to support an artificial intelligence network model or an artificial intelligence network model parameter;
whether to support a plurality of artificial intelligence network models or a plurality of sets of artificial intelligence network model parameters; or
whether to support using an artificial intelligence network model or an artificial intelligence network model parameter to obtain or optimize positioning signal measurement information.

19. A communication device, comprising: a memory storing a computer program; and a processor coupled to the memory and configured to execute the computer program to perform operations comprising:
determining whether to use an artificial intelligence network model or an artificial intelligence network model parameter or determining an artificial intelligence network model or artificial intelligence network model parameter to be used according to first information, wherein the artificial intelligence network model is configured to obtain or optimize positioning signal measurement information of a target terminal or location information of the target terminal.

20. A non-transitory computer-readable storage medium, storing a computer program, when the computer program is executed by a processor of a communication device, causes the processor to perform operations comprising:
determining whether to use an artificial intelligence network model or an artificial intelligence network model parameter or determining an artificial intelligence network model or artificial intelligence network model parameter to be used according to first information, wherein the artificial intelligence network model is configured to obtain or optimize positioning signal measurement information of a target terminal or location information of the target terminal.
